(19) United States
(12) Patent Application Publication
(10) Pub. No.: US 2026/0105661 A1
(43) Pub. Date: Apr. 16, 2026

(54) EDITING IMAGES WITH AN IMAGE GENERATION MODEL

(71) Applicant: ADOBE INC., SAN JOSE, CA (US)

(72) Inventors: Nanxuan Zhao, San Jose, CA (US); Yilin Wang, Sunnyvale, CA (US); Hui Qu, Santa Clara, CA (US); Yufan Zhou, Santa Clara, CA (US); Zhe Lin, Clyde Hill, WA (US); Krishna Kumar Singh, San Jose, CA (US); Qing Liu, Santa Clara, CA (US); Yuheng Li, San Jose, CA (US); Yu-Teng Li, San Jose, CA (US); Wei-An Lin, Seattle, WA (US)

(21) Appl. No.: 19/251,079

(22) Filed: Jun. 26, 2025

Related U.S. Application Data
(60) Provisional application No. 63/707,617, filed on Oct. 15, 2024.

(51) Int. Cl. G06T 11/60; G06T 5/60; G06T 5/70; G06T 11/00

(52) U.S. Cl. CPC G06T 11/60; G06T 5/60; G06T 5/70; G06T 11/10; G06T 2207/20081

(57) ABSTRACT

A method, apparatus, non-transitory computer readable medium, and system for image processing include obtaining an input image and a modification prompt, where the input image depicts an object with a first attribute and the modification prompt describes a modification from the first attribute to a second attribute different from the first attribute, encoding the modification prompt to obtain a text embedding, where the text embedding represents the modification in an embedding space, and generating a modified image based on the input image and the text embedding, where the modified image depicts the object with the second attribute.

### CROSS-REFERENCE TO RELATED APPLICATION

This application claims priority under 35 U.S.C. § 119 to U.S. Provisional Application No. 63/707,617, filed on Oct. 15, 2024, in the United States Patent and Trademark Office, the disclosure of which is incorporated by reference herein in its entirety

### BACKGROUND

The following relates generally to image processing, and more specifically to image editing using a machine learning model. Image processing refers to the use of a computer to edit an image using an algorithm or a processing network. In some cases, image processing software can be used for various image processing tasks, such as image restoration, image detection, image generation, image compositing, and image editing.

In some cases, image editing includes the use of a machine learning model to edit an input image based on a conditioning to generate a modified image. For example, the machine learning model is trained to generate an edited image based on a text prompt, a mask input, and/or an input image. In some cases, the edited image may depict a modification to the input image, such as a change from a first element to a second element.

### SUMMARY

Embodiments of the present disclosure provide a method and a system for image editing using generative models. In one aspect, the system generates a modified image depicting a change described by a modification prompt based on an input image and the modification prompt. In one aspect, the system includes a text encoder configured to encode the modification prompt to obtain a text embedding. The system includes an image generation model trained to generate a modified image based on the input image and the text embedding. In an embodiment, the image generation model includes a diffusion model configured to guide the image generation process using cross-attention mechanisms. The image generation model generates the modified image by editing the object or attribute described by the modification prompt while preserving other visual features of the input image. In some aspects, the image generation model is trained using a first synthetic image generated based on a prompt describing an object and a second synthetic image generated based on a change to the prompt.

A method, apparatus, non-transitory computer readable medium, and system for image processing include obtaining an input image and a modification prompt, where the input image depicts an object with a first attribute and the modification prompt describes a modification from the first attribute to a second attribute different from the first attribute, encoding, using a text encoder, the modification prompt to obtain a text embedding, where the text embedding represents the modification in an embedding space, and generating, using an image generation model, a modified image based on the input image and the text embedding, where the modified image depicts the object with the second attribute.

A method, apparatus, non-transitory computer readable medium, and system for image processing include obtaining an input image and a modification prompt that indicates a modification to the input image, and generating, using an image generation model, a modified image based on the input image and the modification prompt, where the modified image depicts content from the input image with the modification from the modification prompt, and where the image generation model is trained using a first predicted image generated based on a caption and a second predicted image generated based on a change to the caption.

A method, apparatus, non-transitory computer readable medium, and system for training a machine learning model includes obtaining a training set including a training image, a modification prompt describing a change to the training image, and a modified training image depicting the change to the training image; encoding, using a text encoder, the modification prompt to obtain a text embedding, wherein the text embedding represents the modification in an embedding space; and training, using the training set and the text embedding, an image generation model to generate a synthetic image based on the modification prompt.

An apparatus and system for image processing include a memory component, and a processing device coupled to the memory component, the processing device configured to perform operations including: obtaining an input image and a modification prompt, where the input image depicts an object with a first attribute and the modification prompt describes a modification from the first attribute to a second attribute different from the first attribute, encoding, using a text encoder, the modification prompt to obtain a text embedding, where the text embedding represents the modification in an embedding space, and generating, using an image generation model, a modified image based on the input image and the text embedding, where the modified image depicts the object with the second attribute.

### BRIEF DESCRIPTION OF THE DRAWINGS

FIG. 1 shows an example of an image processing system according to aspects of the present disclosure.

FIG. 2 shows an example of a method for conditional image editing according to aspects of the present disclosure.

FIG. 3 shows an example of a method for generating a modified image according to aspects of the present disclosure.

FIG. 4 shows an example of image editing using text prompt according to aspects of the present disclosure.

FIG. 5 shows an example of output image refinement according to aspects of the present disclosure.

FIG. 6 shows an example of a machine learning model according to aspects of the present disclosure.

FIG. 7 shows an example of an image generation system according to aspects of the present disclosure.

FIG. 8 shows an example of an image generation model according to aspects of the present disclosure.

FIG. 9 shows an example of a U-Net architecture according to aspects of the present disclosure.

FIG. 10 shows an example of a diffusion transformer model according to aspects of the present disclosure.

FIG. 11 shows an example of a diffusion process according to aspects of the present disclosure.

FIG. 12 shows an example of a method for training a machine learning model according to aspects of the present disclosure.

FIG. 13 shows an example of training data generation according to aspects of the present disclosure.

FIG. 14 shows an example of a flow diagram depicting an algorithm as a step-by-step procedure in an example implementation of operations performable for training a machine learning model according to aspects of the present disclosure.

FIG. 15 shows an example of a method for training a diffusion model according to aspects of the present disclosure.

FIG. 16 shows an example of an image processing apparatus according to aspects of the present disclosure.

FIG. 17 shows an example of a computing device according to aspects of the present disclosure.

### DETAILED DESCRIPTION

Embodiments of the present disclosure relate to image editing using generative machine learning. Some embodiments of the disclosure relate to an image generation system that accurately generates a modified image that depicts a modification from a first attribute to a second attribute of an object in the input image. In some cases, the modified image depicts a modification from a first object to a second object while maintaining the attribute of the first object. In some aspects, the system includes a text encoder configured to generate a text embedding based on a modification prompt. The text embedding is provided to an image generation model of the system to ensure that the synthetic image accurately depicts a modification of the attribute or the object described by the modification prompt.

In the field of image editing, particularly in image element modification, a machine learning system is used to replace one image element (e.g., an attribute or an object) with another image element described by a text prompt. Conventional image editing systems take multiple inputs to condition the model to generate an edited image. For example, the inputs include an input image, a text prompt, and a mask input. However, in some cases, these systems may alter an image element not described by the text prompt. As a result, these systems fail to preserve the image identity of the image element.

Some conventional image generation systems are configured to edit images based on specific instructions. However, in some cases, these systems may overinterpret vague instructions or misinterpret complex instructions, resulting in edits that do not align with the intent of the user. In some cases, these systems generate images that have a loss in image quality. For example, these systems use an iterative editing process, which may degrade the overall quality of the output image and the introduction of artifacts or blurred details.

Some systems are configured to edit an attribute or visual characteristic of an object depicted in the input image. For example, a visual characteristic of the object may include color, texture, shape, contrast, brightness, pattern, edge, and/or orientation. However, these systems may be unable to maintain the texture or lighting of the object when editing the image, especially across complex areas of the image. In some cases, the edited object or feature may appear unnatural or poorly integrated into the scene of the image, which lowers the aesthetics of the overall composition of the output image.

Accordingly, the present disclosure provides a system and method that improve on conventional image generation systems by accurately editing an image element described by a modification prompt while preserving an attribute of the image element. For example, when providing a prompt that states “change spoon to fork” and an input image depicting the spoon, the modified image depicts the fork having the same color tone and texture as the spoon depicted in the input image. This is achieved using a system that includes an image generation model that uses the input image to initiate the image generation process, and uses the text embedding of the modification prompt as guidance.

According to some aspects, the system receives an input image and a modification prompt to generate an edited image (e.g., the modified image). In one aspect, the system includes a text encoder configured to generate a text embedding based on the modification prompt. In some aspects, the text embedding represents a modification from one image element (e.g., an attribute or an object) to another image element. By using the text embedding to guide the image generation process, the image generation model can accurately identify the image element to be modified within the input image.

According to some aspects, the system includes an image generation model trained to generate an edited image (e.g., a modified image) based on the input image and the text prompt. By using the input image to initialize the image generation process, the image generation model can accurately preserve other image elements while making edits on the image element described by the text prompt.

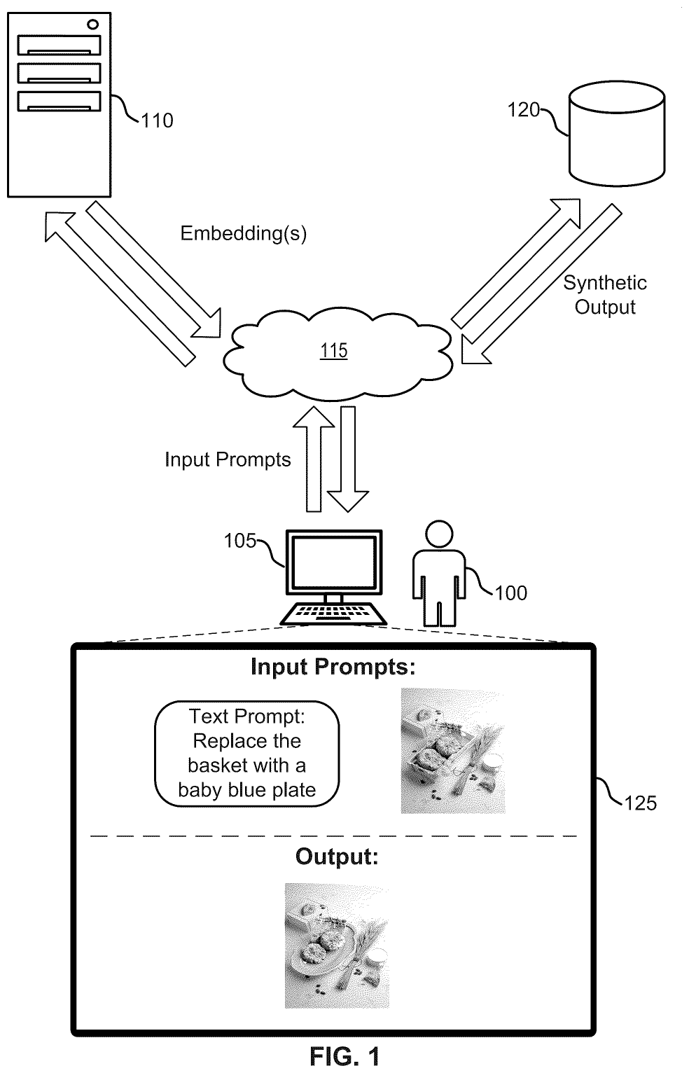

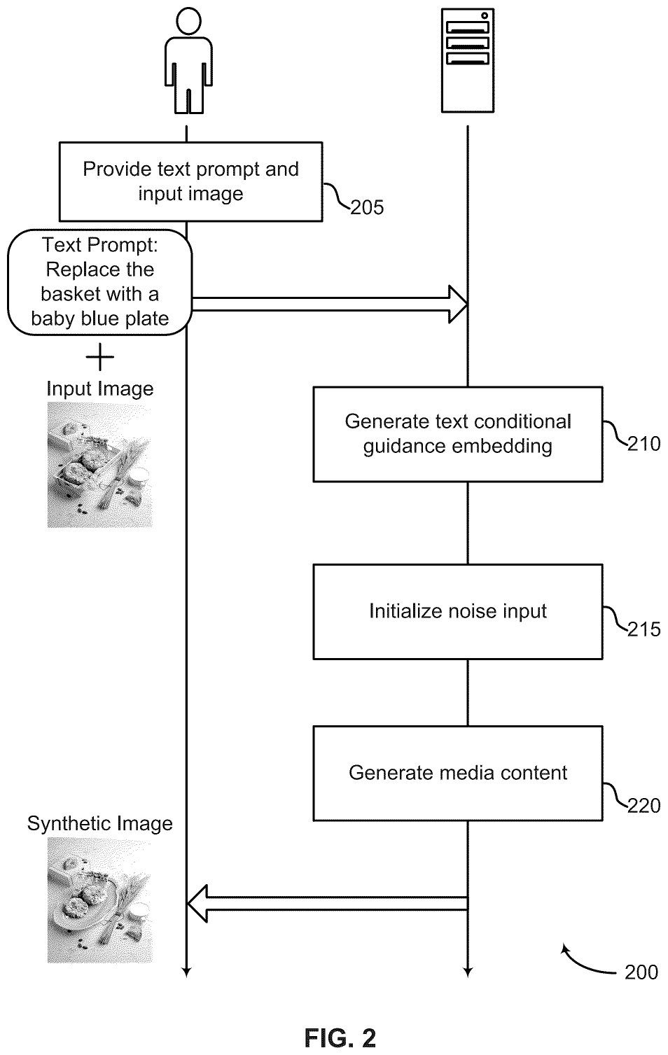

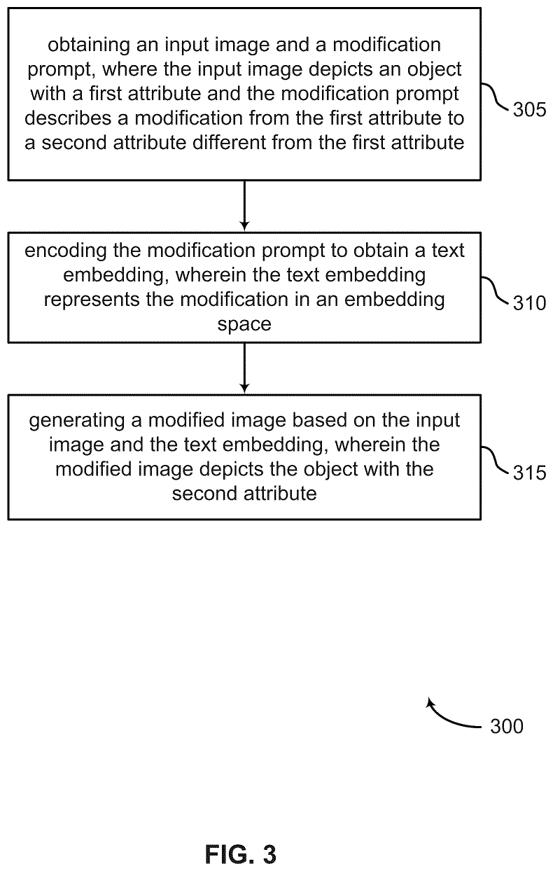

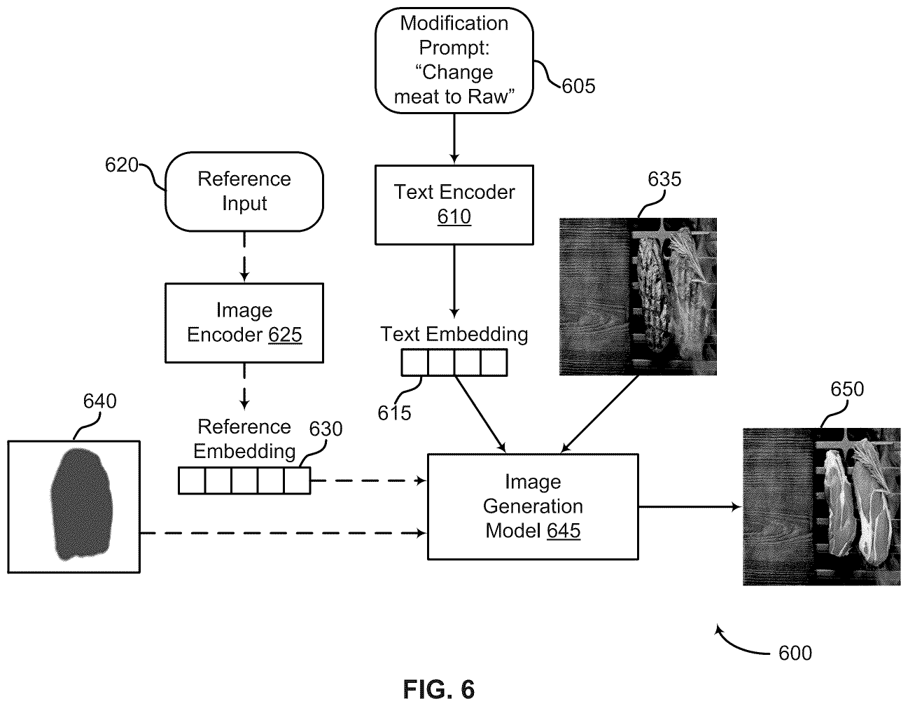

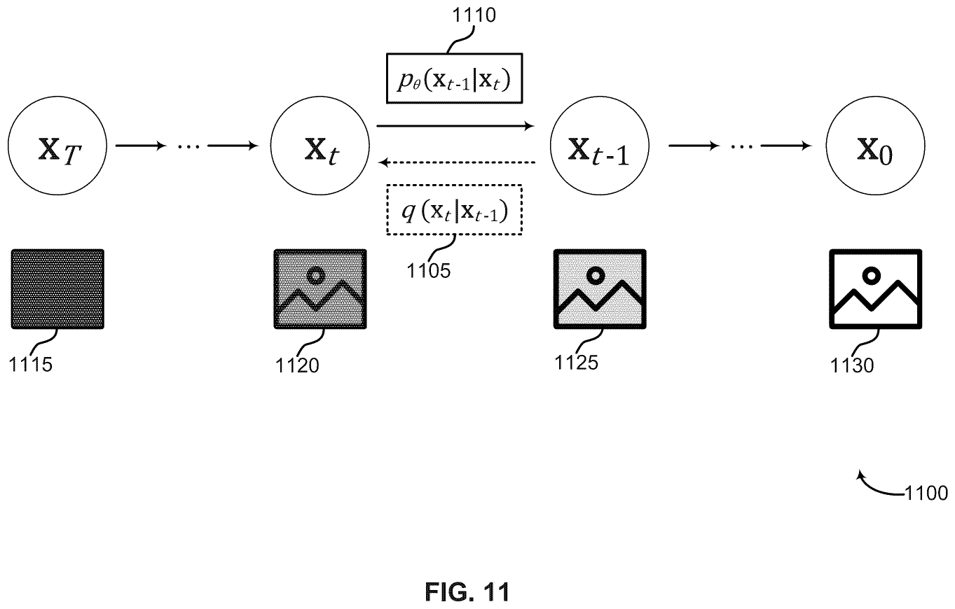

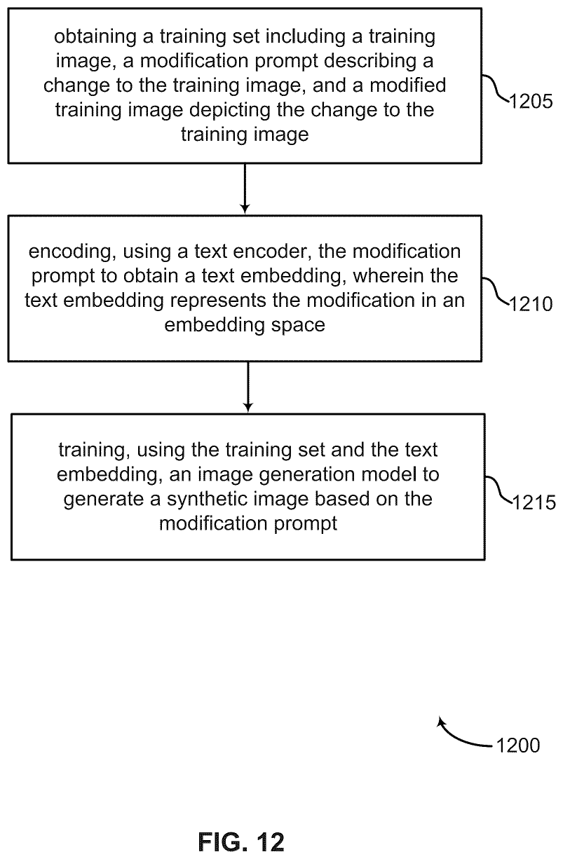

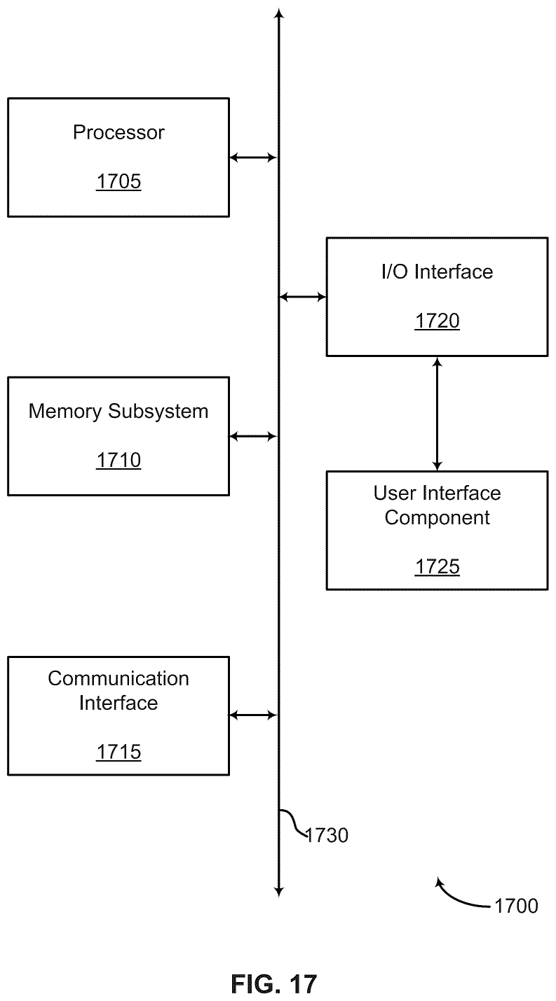

An example system of the inventive concept in image processing is provided with reference to FIGS. 1 and 17. An example application of the inventive concept in image processing is provided with reference to FIGS. 2 and 4-5. Details regarding the architecture of an image processing apparatus are provided with reference to FIGS. 6-10 and 16. An example of a process for image processing is provided with reference to FIGS. 3 and 11. A description of an example training process is provided with reference to FIGS. 12-15.

Accordingly, embodiments of the disclosure by generating an edited image more accurately. In some aspects, the system of the disclosure can be used with various types of diffusion models, including a pixel-based diffusion model or a latent-based diffusion model. According to some aspects, the system is jointly trained with multi-tasks including inpainting, outpainting, editing tasks, segmentation, depth estimation, normal estimation, colorization, and low-level vision. In some cases, the editing tasks include recoloring, retexturing, structure editing, appearance editing, text editing, global editing, and style editing. In some aspects, the image generation model can be further guided by a reference input such as a fine-grained color image, texture image, and reference image. In some aspects, the image generation model can be pretrained, thereby reducing training costs. In some embodiments, the image generation model uses dual classifier-free guidance (CFG), thereby enhancing the image quality of the modified image.

As used herein, an input image, image, reference image, or training image depicts one or more objects, elements, or scenes. The image serves as the visual basis for generating a modified image. The input image may include visual information such as shape, color, texture, and spatial arrangement of elements.

A modification prompt refers to a text-based instruction describing a target change to be applied to the input image. The modification prompt may describe a transformation from a first attribute or object to a second attribute or object. For example, the modification prompt may state “change hat to helmet” or “make the blue sky into sunset orange.”

An object refers to a distinct visual component depicted in an image, which may include tangible items such as a person, chair, or tree, or conceptual elements such as a scene or background. The object may be targeted for modification or preservation during the image editing process.

An attribute, first attribute, second attribute, or third attribute refers to a property, characteristic, or visual feature of an object depicted in the input image. Attributes may include tangible characteristics such as shape, size, color, and structure, as well as non-tangible elements such as lighting, texture, shading, glossiness, and contrast. In some cases, an attribute may refer to an object, element, or a scene of an image (e.g., an object depicted in an input image).

An embedding is a numerical vector representation of input data in a continuous, low-dimensional space used for performing machine learning tasks. A text embedding is a vector representation of a modification prompt or other textual input, capturing the semantic meaning of the modification prompt. The text embedding is generated using a text encoder and is used to guide the image generation model. An image embedding is a numerical representation of visual features extracted from an image (e.g., input image, reference image). The image embedding captures elements such as shape, color, texture, and structure and is used to condition or guide the image generation process.

Latent space refers to a continuous, multi-dimensional space in which embeddings are represented. The latent space encodes semantic or visual features in a compact form, allowing for efficient manipulation and processing. In image generation, both text and image embeddings are positioned in the latent space (or multimodal space) to guide the output generation.

A mask input refers to a binary or multi-valued image indicating specific regions of the input image to be edited. The mask guides the system to apply changes within the masked region, preserving other regions of the image.

A reference input is an auxiliary input image used to guide the style, texture, color, depth, or structure of the generated image. Examples of reference input include style image, color image, depth map, texture map, etc. A style image may be an image that depicts an artistic style. A color image may be an image depicting target colors or color palettes. A depth may be a grayscale image representing depth information for spatial arrangement. A texture map may be an image including surface-level patterns or textures to be transferred.

An image feature refers to an abstract representation of visual characteristics extracted from an image using a convolutional or transformer-based encoders. These features include spatial, textural, and semantic information and are used by the image generation model to produce modified images. In some cases, image features may be represented in a latent space or embedding space.

### Image Editing

In FIGS. 1-5 and 11, a method, apparatus, non-transitory computer readable medium, and system for image processing include obtaining an input image and a modification prompt, where the input image depicts an object with a first attribute and the modification prompt describes a modification from the first attribute to a second attribute different from the first attribute, encoding, using a text encoder, the modification prompt to obtain a text embedding, where the text embedding represents the modification in an embedding space, and generating, using an image generation model, a modified image based on the input image and the text embedding, where the modified image depicts the object with the second attribute.

In some aspects, the modified image preserves a third attribute of the object. Some examples of the method, apparatus, non-transitory computer readable medium, and system further include obtaining a mask input indicating a region of the input image, where the modified image is generated based on the mask input. Some examples of the method, apparatus, non-transitory computer readable medium, and system further include obtaining a reference input. Some examples further include generating a reference embedding based on the reference input, where the modified image is generated based on the reference embedding.

Some examples of the method, apparatus, non-transitory computer readable medium, and system further include obtaining noise input. Some examples further include denoising the noise input based on the text embedding to obtain the modified image. Some examples of the method, apparatus, non-transitory computer readable medium, and system further include modifying a color of the input image to obtain a modified input image, where the modified image is generated based on the modified input image.

Some examples of the method, apparatus, non-transitory computer readable medium, and system further include generating first image features based on the input image. Some examples further include generating second image features based on the text embedding. Some examples further include combining the first image features and the second image features to obtain combined image features, where the modified image is generated based on the combined image features.

In some aspects, the image generation model is trained to edit images using a training set comprising a training image depicting the object with the first attribute and a training prompt describing the modification from the first attribute to the second attribute. In some aspects, the image generation model is trained using a first predicted image generated based on a caption and a second predicted image generated based on a change to the caption.

A method, apparatus, non-transitory computer readable medium, and system for image processing include obtaining an input image and a modification prompt that indicates a modification to the input image, and generating, using an image generation model, a modified image based on the input image and the modification prompt, where the modified image depicts content from the input image with the modification from the modification prompt, and where the image generation model is trained using a first predicted image generated based on a caption and a second predicted image generated based on a change to the caption.

In some aspects, the modified image preserves a third attribute of the object. Some examples of the method, apparatus, non-transitory computer readable medium, and system further include obtaining a mask input indicating a region of the input image, where the modified image is generated based on the mask input.

Some examples of the method, apparatus, non-transitory computer readable medium, and system further include obtaining a reference input. Some examples further include generating a reference embedding based on the reference input, where the modified image is generated based on the reference embedding.

Some examples of the method, apparatus, non-transitory computer readable medium, and system further include obtaining noise input. Some examples further include denoising the noise input based on the text embedding to obtain the modified image. Some examples of the method, apparatus, non-transitory computer readable medium, and system further include modifying a color of the input image to obtain a modified input image, where the modified image is generated based on the modified input image.

Some examples of the method, apparatus, non-transitory computer readable medium, and system further include generating first image features based on the input image. Some examples further include generating second image features based on the text embedding. Some examples further include combining the first image features and the second image features to obtain combined image features, where the modified image is generated based on the combined image features.

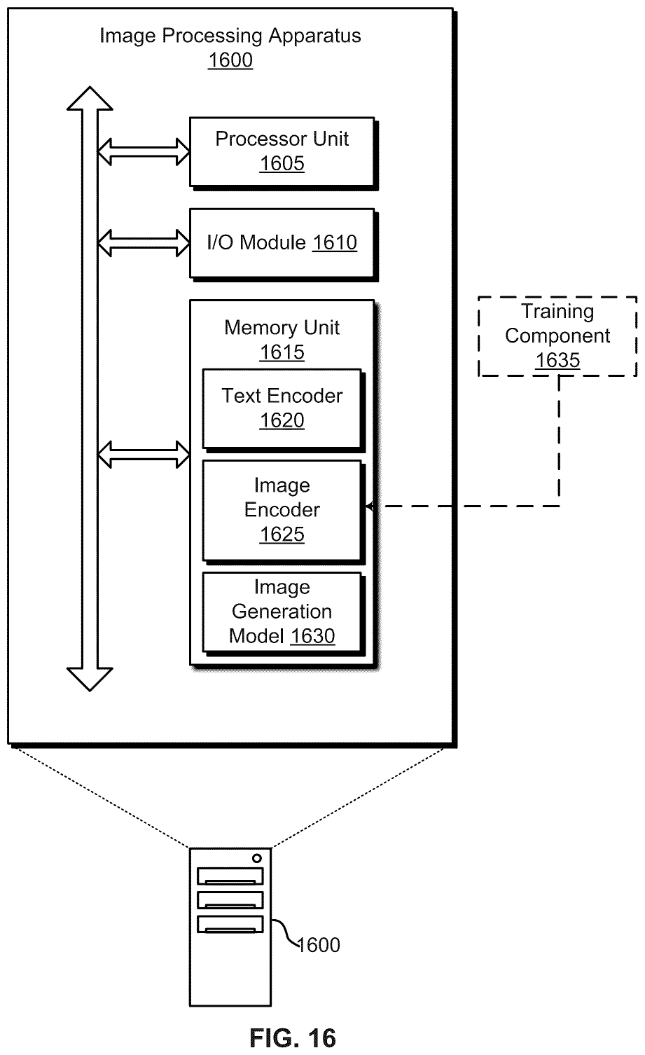

FIG. 1 shows an example of an image processing system according to aspects of the present disclosure. The example shown includes user 100, user device 105, image processing apparatus 110, cloud 115, database 120, and display device 125. In some aspects, user device 105 includes display device 125. Image processing apparatus 110 is an example of, or includes aspects of, the corresponding element described with reference to FIG. 16.

Referring to FIG. 1, user 100 provides an input text prompt (e.g., a modification prompt) and an input image to the image processing apparatus 110 via user device 105 and cloud 115. In some cases, the text prompt describes a modification from a first attribute to a second attribute, or from a first object to a second object. For example, the text prompt states, “Replace the basket with a baby blue plate.” For example, the input image depicts a few breakfast breads in a white plastic basket. In some cases, the image processing apparatus 110 includes a machine learning model that generates a modified image that depicts the change of one object to another object (e.g., from a basket to a baby blue plate) based on the text prompt and the input image. In some cases, an attribute of the object (e.g., the plastic appearance or texture) is preserved in the modified image.

In some aspects, the image processing apparatus 110 includes a text encoder configured to generate a text embedding based on the text prompt. In some cases, the text embedding represents the modification from basket to baby blue plate. In some aspects, the image processing apparatus 110 includes an image generation model trained to generate the modified image depicting the modification. For example, the input image is combined with input noise to initiate the image generation process. Then, the text embedding is used to guide the image generation process, where the image generation model generates the output (e.g., output image feature) that represents the change of the element described by the text prompt. In some aspects, an image decoder decodes the output to generate the modified image. Image processing apparatus 110 displays the modified image via display device 125 of the user device 105 to user 100 via cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

According to some aspects, image processing apparatus 110 includes a computer implemented network comprising a machine learning model, a text encoder, an image encoder, and an image generation model. Image processing apparatus 110 further includes a processor unit, a memory unit, an I/O module, and a training component. In some embodiments, image processing apparatus 110 further includes a communication interface, user interface components, and a bus as described with reference to FIG. 16. Additionally or alternatively, image processing apparatus 110 communicates with user device 105 and database 120 via cloud 115. Image processing apparatus 110 is an example of, or includes aspects of, the corresponding element described with reference to FIG. 6. Further details regarding the operation of image processing apparatus 110 are described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including a training image depicting an object with a first attribute and a training prompt describing a modification from the first attribute to a second attribute different from the first attribute. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for conditional image editing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides a text prompt and an input image. In some cases, the operations of this step refer to, or may be performed by, a user as described with reference to FIG. 1. In some cases, the user provides the text prompt that describes a modification from one image element to another image element. In some cases, for example, the input image depicts the image element.

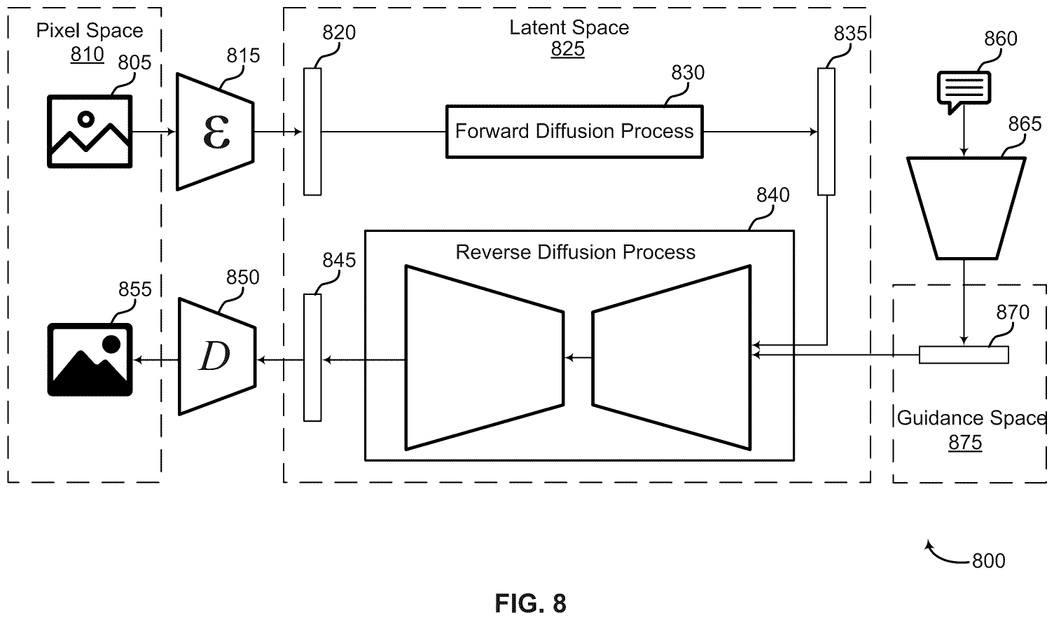

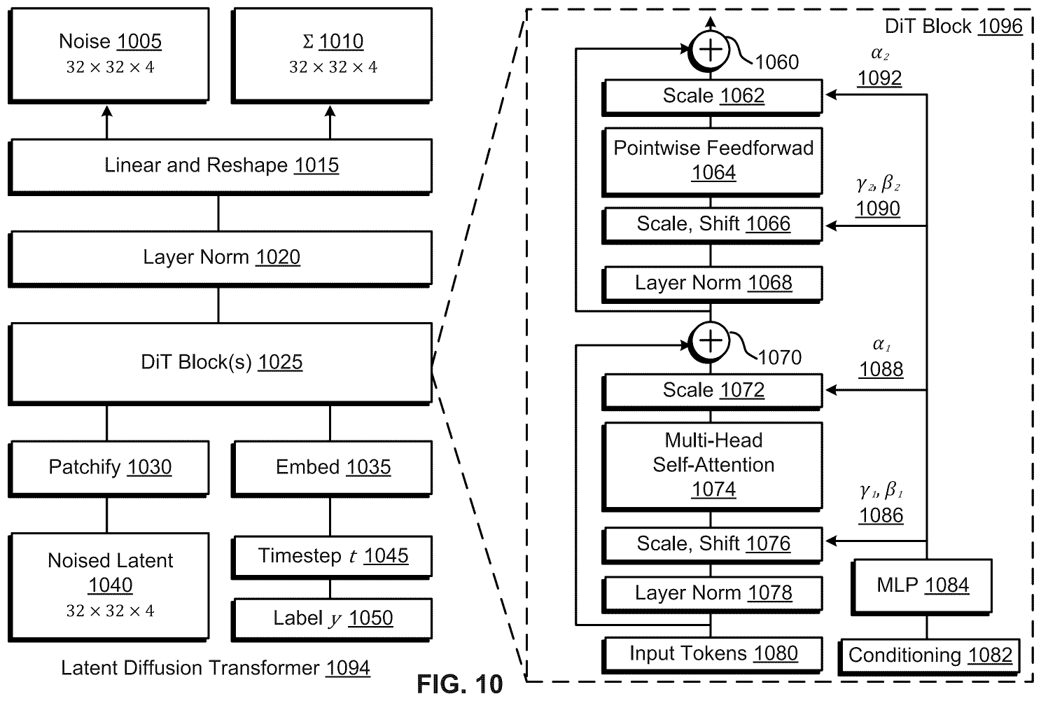

At operation 210, the system generates a text conditional guidance embedding. In some cases, the operations of this step refer to, or may be performed by, an image processing apparatus as described with reference to FIGS. 1 and 16. In some cases, the operations of this step refer to, or may be performed by, a text encoder as described with reference to FIGS. 6-8, and 16. In some cases, the system includes a text encoder configured to encode the text prompt to generate a text embedding. For example, text embedding is used as guidance to guide the image generation process of the image generation model. In some cases, the text embedding is combined with features of the U-Net within the image generation model via a cross-attention layer. Further detail on the U-Net is described with reference to FIGS. 8 and 10.

At operation 215, the system initializes a noise input. In some cases, the operations of this step refer to, or may be performed by, an image processing apparatus as described with reference to FIGS. 1 and 16. In some cases, the operations of this step refer to, or may be performed by, an image generation model as described with reference to FIGS. 6 and 16. In some cases, the noise input including random noise is initialized. The noise input may be in a latent space. By initializing the image generation model with random noise, different variations of a synthetic image can be generated. In some cases, a conditional embedding such as a text encoding or a text embedding may be combined with a noisy feature using a cross-attention block within the image generation model to guide the image generation process.

In some embodiments, the noise input is combined with the input image to obtain a noisy image, where the noisy image is used to initiate the image generation process. For example, the noisy image includes visual features of one or more image elements depicted in the input image. By initializing the image generation model using the noisy image, one or more image elements can be preserved in the output image. Further detail on the image generation process is described with reference to FIG. 8.

At operation 220, the system generates media content. In some cases, the operations of this step refer to, or may be performed by, an image processing apparatus as described with reference to FIGS. 1 and 16. In some cases, the operations of this step refer to, or may be performed by, an image generation model as described with reference to FIGS. 6 and 16. In some cases, the media content includes a modified image. For example, the modified image depicts a change of an image element described by the text prompt.

FIG. 3 shows an example of a method 300 for generating a modified image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 305, the system obtains an input image and a modification prompt, where the input image depicts an object with a first attribute and the modification prompt describes a modification from the first attribute to a second attribute different from the first attribute. In some cases, the operations of this step refer to, or may be performed by, an image generation model as described with reference to FIGS. 6 and 16. In some cases, modification prompt is a text prompt that describes a change from one image element to another. In some cases, an image element includes an attribute or an object. For example, the attribute may describe the visual appearance or image features that make up the overall composition of an image, such as subject, shape, color, texture, pattern, background scene, visual attributes, and/or style. In some cases, the object includes a person, animal, and non-living things such as tables, chairs, plants, etc. In some embodiments, the modification prompt may describe a modification from a first object to a second object different from the first object.

At operation 310, the system encodes the modification prompt to obtain a text embedding, where the text embedding represents the modification in an embedding space. In some cases, the operations of this step refer to, or may be performed by, a text encoder as described with reference to FIGS. 6-8, and 16. In some embodiments, the system generates an image embedding based on a reference input or reference image. In some cases, the text embedding and the image embedding are used to guide the image generation process.

In some cases, a text embedding is a numerical vector that captures the semantic meaning of the text, encoding words, phrases, or sentences into a dense, continuous space. For example, the text embedding is encoded into a text embedding space, which is a low-dimensional vector space. The text embedding is generated by passing the text prompt through an encoder (e.g., a text encoder or multi-modal encoder) that learns the relationships between words based on the context within large corpora of text. In some cases, the text embedding represents textual features (e.g., the semantic meaning, relationship between words, or lexical features) of the text prompt.

In some cases, a text embedding space is a continuous, low-dimensional vector space where each vector represents the semantic meaning of the text. Points in the text embedding space are organized such that text with similar meanings are located near each other, reflecting the relationships between different words, phrases, or sentences based on contextual usage.

For example, image embedding captures the essential visual features or visual characteristics of an image, such as color, texture, shape, and spatial relationships. In some aspects, the transformer prior model is trained to generate an image embedding based on the text prompt, where the image embedding includes visual features of the image element described by the text prompt.

In some cases, an image embedding space is a high-dimensional vector space where each point corresponds to an image's visual representation. In the image embedding space, the distance between points reflects the similarity of the visual features of the images. In some cases, similar images are located closer to each other based on the characteristics encoded in the image embeddings. In some cases, the text embedding and the image embedding are combined in a joint embedding space.

At operation 315, the system generates a modified image based on the input image and the text embedding, where the modified image depicts the object with the second attribute. In some cases, the operations of this step refer to, or may be performed by, an image generation model as described with reference to FIGS. 6 and 16. In some cases, the modified image includes image pixels from the input image and image pixels generated by the image generation model. In some cases, the modified image includes image pixels generated by the image generation model.

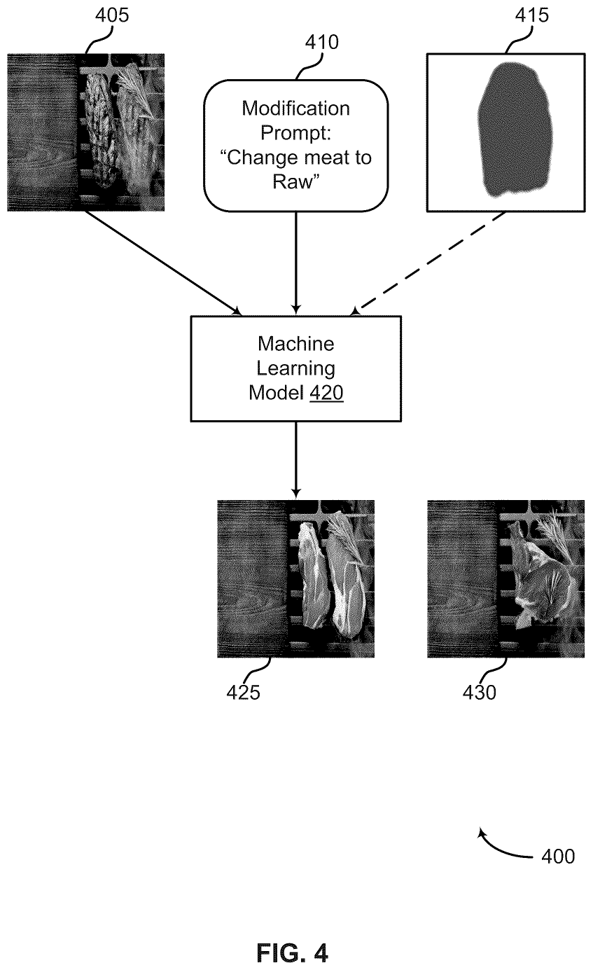

FIG. 4 shows an example of image editing using text prompt according to aspects of the present disclosure. The example shown includes image editing system 400, input image 405, modification prompt 410, mask 415, machine learning model 420, modified image 425, and conventional modified image 430. In some embodiments, the image editing system 400 is implemented in a user interface.

Referring to FIG. 4, image editing system 400 receives input image 405 and modification prompt 410 and generates modified image 425. In some embodiments, image editing system 400 receives input image 405, modification prompt 410, and mask 415 as inputs to generate the modified image 425. In some embodiments, image editing system 400 receives one or more reference inputs to generate the modified image 425. For example, the reference inputs may include fine-grained color image, texture image, and reference image.

According to some embodiments, the machine learning model 420 receives input image 405 and modification prompt 410 as inputs. For example, the input image 405 depicts two pieces of cooked steak placed on a grill. For example, the modification prompt 410 describes a modification (e.g., a change of image element) such as “Change meat to raw.” In some aspects, the machine learning model 420 includes a text encoder configured to encode the modification prompt 410 to generate a text embedding. In some aspects, the machine learning model 420 includes an image generation model trained to generate the modified image 425 based on the input image 405 and the text embedding. For example, the image generation process is initialized by using the input image 405, and the image generation process is guided by using the text embedding. By initializing the image generation process using the input image 405, the image element (e.g., the cooked steak) described by the modification prompt 410 is changed while other image elements (such as color, shape, texture, etc.) of the input image 405 are preserved. For example, the shape of the cooked steak is preserved.

According to some embodiments, the modified image 425 is further generated based on the mask 415. For example, the mask 415 indicates a region (e.g., a coarse region or a fine region) of the input image 405 that depicts the image element (e.g., the cooked steak). By using the mask 415 to guide the image generation process, the accuracy of the image generation model can be further improved.

Conventional image generation system receives a text prompt describing the modification to an image element and an input image 405 depicting the image element to generate the conventional modified image 430. In some cases, the input image 405 is combined with a mask (e.g., the mask 415) to generate a masked image, where the masked image is used to initialize the image generation process. However, conventional systems might not be able to accurately generate the correct pixels in the region indicated by the mask 415. Accordingly, new pixels may be generated causing an attribute of the image to be altered. For example, the shape and size of the steak depicted in conventional modified image 430 is different from the steak depicted in the input image 405, whereas the shape and size of the steak depicted in modified image 425 is preserved.

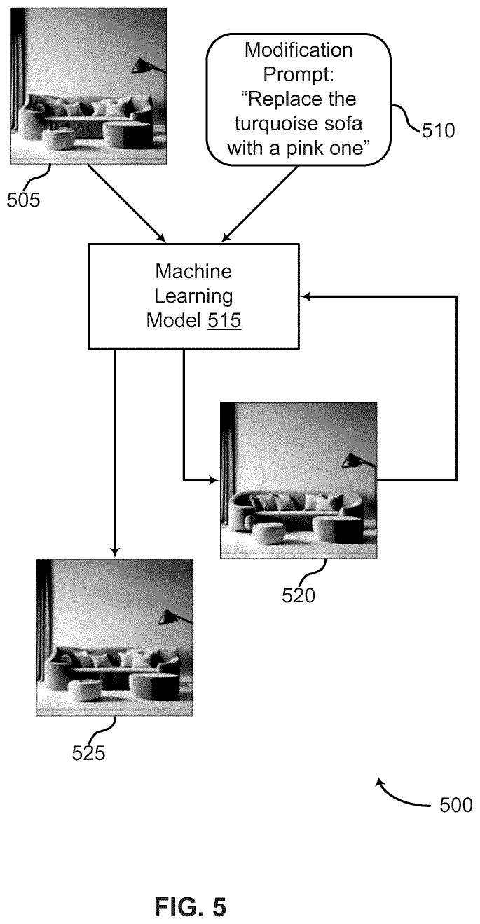

Image editing system 400 is an example of, or includes aspects of, the corresponding element described with reference to FIG. 5. Input image 405 is an example of, or includes aspects of, the corresponding element described with reference to FIGS. 5-7. Modification prompt 410 is an example of, or includes aspects of, the corresponding element described with reference to FIGS. 5 and 6.

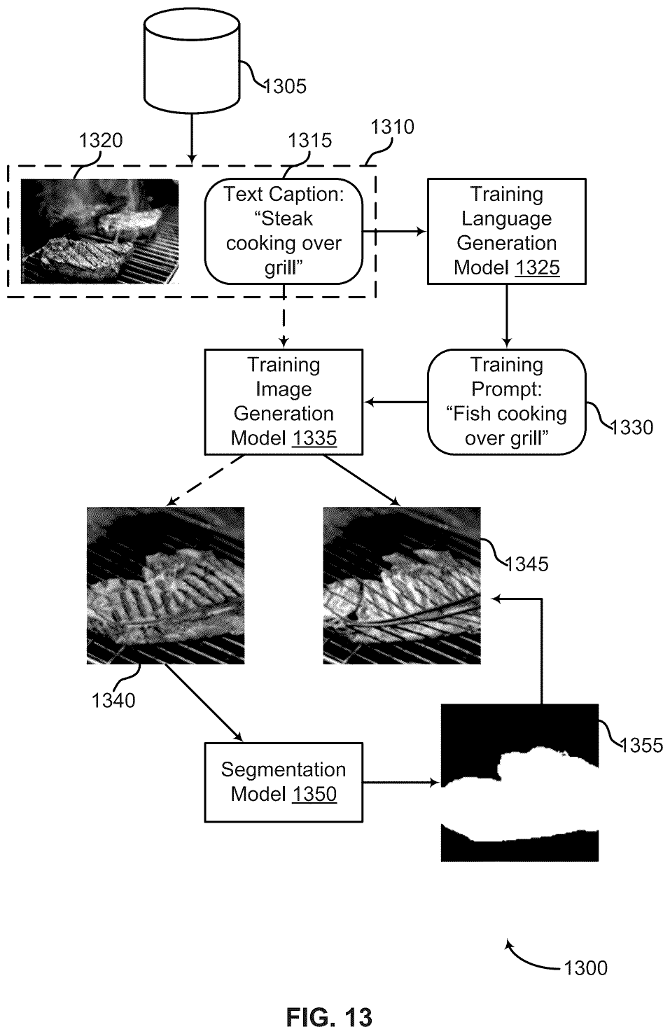

Mask 415 is an example of, or includes aspects of, the corresponding element described with reference to FIG. 13. Machine learning model 420 is an example of, or includes aspects of, the corresponding element described with reference to FIG. 5. Modified image 425 is an example of, or includes aspects of, the corresponding element described with reference to FIGS. 5 and 6.

FIG. 5 shows an example of output image refinement according to aspects of the present disclosure. The example shown includes image editing system 500, input image 505, modification prompt 510, machine learning model 515, modified image 520, and refined image 525. In some embodiments, the image editing system 500 is implemented in a user interface.

Referring to FIG. 5, image editing system 500 receives input image 505 and modification prompt 510 and generates refined image 525. In some embodiments, machine learning model 515 receives the input image 505 and the modification prompt 510 and generates modified image 520. The process of generating the modified image 520 is substantially the same as described in FIG. 4. According to some embodiments, modified image 520 is input into the machine learning model 515 to generate the refined image 525. For example, the machine learning model 515 generates an input image feature based on the input image 505 and generates a modified image feature based on the modified image 520. By interpolating the image features, image generation model of the machine learning model 515 can generate the refined image 525 having enhanced identity preservation. For example, the stool sofas around the turquoise sofa and the shape of the turquoise sofa remain unchanged, while the color of the turquoise sofa is modified based on the modification prompt 510.

Image editing system 500 is an example of, or includes aspects of, the corresponding element described with reference to FIG. 4. Input image 505 is an example of, or includes aspects of, the corresponding element described with reference to FIGS. 4, 6, and 7. Modification prompt 510 is an example of, or includes aspects of, the corresponding element described with reference to FIGS. 4 and 6.

Machine learning model 515 is an example of, or includes aspects of, the corresponding element described with reference to FIG. 4. Modified image 520 is an example of, or includes aspects of, the corresponding element described with reference to FIGS. 4 and 6.

### System Architecture

In FIGS. 6-10 and 16-17, an apparatus and system for image processing include a memory component, and a processing device coupled to the memory component, the processing device configured to perform operations including: obtaining an input image and a modification prompt, where the input image depicts an object with a first attribute and the modification prompt describes a modification from the first attribute to a second attribute different from the first attribute, encoding, using a text encoder, the modification prompt to obtain a text embedding, where the text embedding represents the modification in an embedding space, and generating, using an image generation model, a modified image based on the input image and the text embedding, where the modified image depicts the object with the second attribute.

In some aspects, the image generation model comprises a diffusion model. In some aspects, the modified image preserves a third attribute of the object. Some examples of the apparatus and system further include an image encoder configured to generate a reference embedding based on a reference input, where the modified image is generated based on the reference embedding.

FIG. 6 shows an example of a machine learning model according to aspects of the present disclosure. The example shown includes machine learning system 600, modification prompt 605, text encoder 610, text embedding 615, reference input 620, image encoder 625, reference embedding 630, input image 635, mask input 640, image generation model 645, and modified image 650. In some aspects, the machine learning system 600 includes text encoder 610, the image encoder 625, and the image generation model 645.

Referring to FIG. 6, according to some embodiments, machine learning system 600 receives modification prompt 605 and input image 635 and generates modified image 650. For example, text encoder 610 receives modification prompt 605 that states “Change meat to raw” and generates text embedding 615 that represents the modification in the embedding space. The text embedding 615 is provided to the image generation model 645 to guide the image generation process. In some cases, the input image 635 is provided to the image generation model 645 to initiate the image generation process.

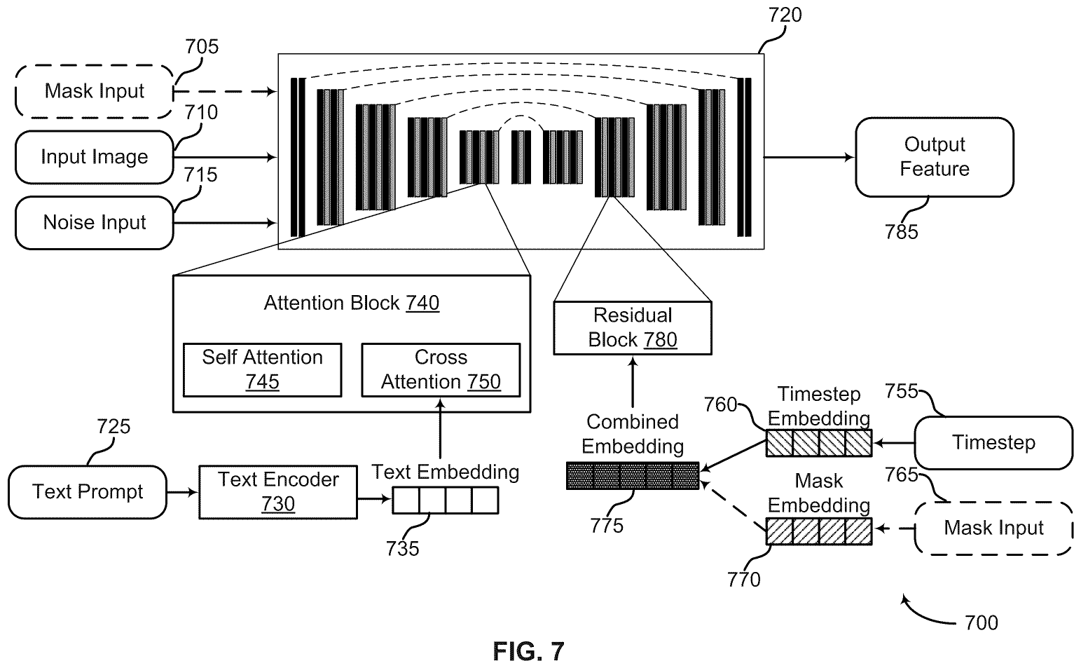

For example, the input image 635 is combined with a noise input to initialize the reverse diffusion process of the image generation model 645. In some embodiments, the input image 635 is used as guidance to guide the image generation process. For example, an image embedding is generated based on the input image 635, and the image embedding is combined with the text embedding 615 to guide the image generation process. Further detail on guidance embedding is described with reference to FIG. 8. In one aspect, the image generation model 645 generates modified image 650 based on the text embedding 615 and the input image 635. Further detail on the image generation process using the image generation model 645 is described with reference to FIG. 7.

In some embodiments, the image generation model 645 receives one or more reference inputs (e.g., reference input 620) to further guide the image generation process. In some cases, for example, the reference input 620 includes a fine-grained color image, texture image, or style image. For example, an image encoder 625 receives the reference input 620 and generates reference embedding 630. In some cases, the reference embedding is an image embedding. In some embodiments, the reference embedding 630 is combined with the text embedding 615 to guide the image generation process.

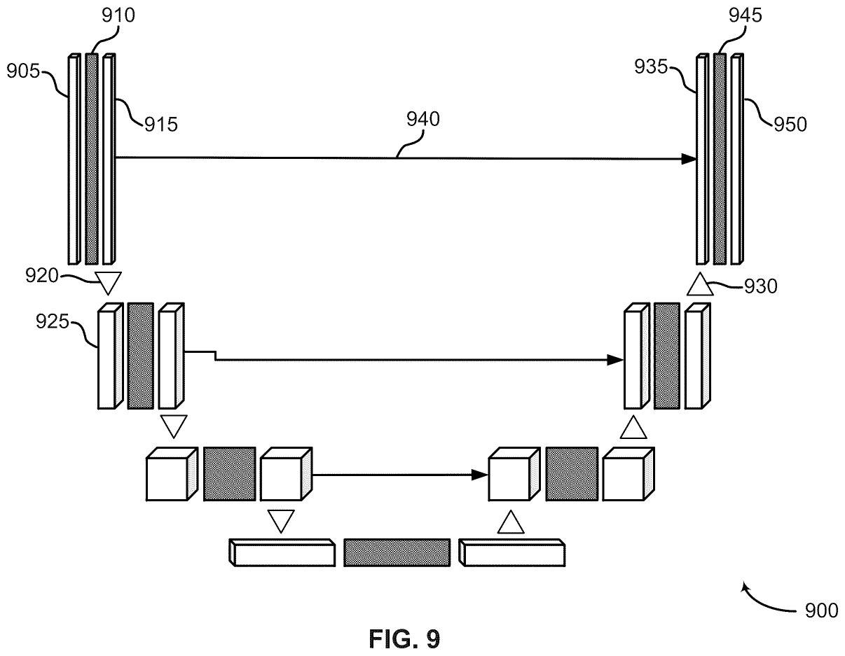

In some embodiments, the machine learning system 600 performs global style transfer to generate the modified image 650. For example, a training-free algorithm is derived by scaling the activations of modality-specific learnable attention and applying inversion to preserve the identity of the object depicted in input image 635. In some embodiments, the image generation model 645 is trained with modality-specific attentions. In some aspects, conditioning the image generation model 645 with a text prompt (e.g., modification prompt 605) and a style image (e.g., the reference input 620) enables the image generation model 645 to generate stylized outputs when each of the modality-specific attention outputs is scaled accordingly. For example, the modality attention from the image (e.g., the modality attention of the reference embedding 630) is scaled down in the middle-resolution layer or lower resolution layers of the U-Net as described with reference to FIG. 9. Additionally, the high-resolution layer of the U-Net is scaled up. In some cases, inversion is applied to generate a latent feature (e.g., representation in the latent space) of the input image 635, and the system denoises the latent back into an image (e.g., the modified image 650) while conditioning on style reference image (e.g., the reference input 620).

In some embodiments, the machine learning system 600 performs fine-grained color control for editing the color of the input image 635. For example, the image generation model 645 receives a color patch with a predetermined color as a reference (e.g., the reference input 620). For example, the color patch is a small, defined area of uniform color that represents standardized colors. The image encoder 625 (or a multimodal encoder) encodes the visual feature of the color patch to obtain the reference embedding 630. In some cases, the reference embedding 630 of the color patch includes precise color information (e.g., representing hex code or RGB value). The image generation model 645 uses the reference embedding 630 as guidance to generate the modified image 650, where the color (either color of the entire image or a portion of the image) is controlled by the hex code or RGB value.

In some embodiments, the image generation model 645 further receives mask input 640 to generate the modified image 650. For example, the mask input 640 indicates a region (e.g., a coarse region or fine region) where the object or an attribute of the object is to be modified. In some cases, the image generation model 645 is able to identify the region independent of the mask input 640. In some cases, a mask embedding is generated based on the mask input 640, and the mask embedding is combined with a convolutional layer in the residual block of the decoder of the U-Net of the image generation model 645. Further detail on the image generation process using the mask input 640 is described with reference to FIG. 8.

According to some embodiments, the machine learning system 600 performs dual classifier-free guidance (CFG) to further enhance the image quality. CFG is a technique used to enhance the image quality in generated images using a diffusion-based image generation model. For example, in CFG, the model generates images by balancing two outputs, one condition on a prompt (e.g., a text prompt) and the other unconditioned. In dual CFG, two guidance signals are used. For example, the first guidance signal is used to guide the image generation based on a specific input (e.g., text, image, mask, reference image, color, etc.), and the second guidance signal steers the model away from undesired outputs, thereby providing finer control over the result. Dual CFG enhances the fidelity of generated images by maintaining coherence with the prompt while preventing the generation of unrealistic or unwanted elements.

Modification prompt 605 is an example of, or includes aspects of, the corresponding element described with reference to FIGS. 4 and 5. Text encoder 610 is an example of, or includes aspects of, the corresponding element described with reference to FIGS. 7, 8, and 16. Text embedding 615 is an example of, or includes aspects of, the corresponding element described with reference to FIG. 7. Image encoder 625 is an example of, or includes aspects of, the corresponding element described with reference to FIGS. 8 and 16.

Input image 635 is an example of, or includes aspects of, the corresponding element described with reference to FIGS. 4, 5, and 7. Mask input 640 is an example of, or includes aspects of, the corresponding element described with reference to FIG. 7. Image generation model 645 is an example of, or includes aspects of, the corresponding element described with reference to FIG. 16. Modified image 650 is an example of, or includes aspects of, the corresponding element described with reference to FIGS. 4 and 5.

FIG. 7 shows an example of an image generation system 700 according to aspects of the present disclosure. The example shown includes image generation system 700, mask 705, input image 710, noise input 715, U-Net 720, text prompt 725, text encoder 730, text embedding 735, attention block 740, timestep 755, timestep embedding 760, mask input 765, mask embedding 770, combined embedding 775, residual block 780, and output feature 785. In one aspect, attention block 740 includes self-attention layer 745 and cross-attention layer 750.

In some aspects, FIG. 7 shows the image generation process of one diffusion timestep. In some aspects, the image generation process is performed iteratively, where the output feature is used as input for the subsequent image generation iteration. Referring to FIG. 7, image generation system 700 receives input image 710 and text prompt 725 and generates output feature 785. For example, input image 710 is combined with noise input 715 to obtain a noisy image, where the noisy image is provided to the U-Net 720 of the image generation model to initialize the image generation process. In some embodiments, a mask 705 is further provided to the U-Net 720.

In some embodiments, the text prompt 725 (e.g., modification prompt described with reference to FIGS. 4-6) is provided to a text encoder 730 to generate the text embedding 735. The text embedding 735 is combined with features generated by the U-Net 720 via cross-attention. For example, the U-Net 720 includes one or more attention blocks, where each attention block 740 includes a self-attention layer 745 and a cross-attention layer 750. The text embedding 735 is added to an intermediate feature generated based on the input image 710 and noise input 715 via a cross-attention mechanism in cross-attention layer 750.

In some embodiments, the timestep 755 is combined with the intermediate output feature of the U-Net 720. For example, timestep embedding 760 is obtained based on the timestep 755, where the timestep embedding 760 is provided to the residual block 780 of the U-Net 720. In some embodiments, a mask input 765 is combined with the intermediate output feature of the U-Net 720. For example, mask embedding 770 is obtained based on the mask input 765, where the mask embedding 770 is combined with the timestep embedding 760 to generate the combined embedding 775. In some cases, combined embedding 775 is provided to the residual block 780 of the U-Net 720. In some cases, the intermediate output feature is upsampled to generate the output feature 785. According to some embodiments, the output feature 785 is used as input to the U-Net 720 for the subsequent image generation step.

Mask 705 is an example of, or includes aspects of, the corresponding element described with reference to FIG. 6. Input image 710 is an example of, or includes aspects of, the corresponding element described with reference to FIGS. 4-6. U-Net 720 is an example of, or includes aspects of, the corresponding element described with reference to FIG. 9.

Text prompt 725 is an example of, or includes aspects of, the corresponding element described with reference to FIG. 8. Text encoder 730 is an example of, or includes aspects of, the corresponding element described with reference to FIGS. 6, 8, and 16. Text embedding 735 is an example of, or includes aspects of, the corresponding element described with reference to FIG. 6.

Mask 705 is an example of, or includes aspects of, the corresponding element described with reference to FIG. 6. Output feature 785 is an example of, or includes aspects of, the corresponding element described with reference to FIG. 9.

FIG. 8 shows an example of an image generation model according to aspects of the present disclosure. The example shown includes diffusion model 800, original image 805, pixel space 810, image encoder 815, original image feature 820, latent space 825, forward diffusion process 830, noisy feature 835, reverse diffusion process 840, denoised image feature 845, image decoder 850, output image 855, text prompt 860, text encoder 865, guidance feature 870, and guidance space 875.

Diffusion models are a class of generative neural networks that can be trained to generate new data with features similar to features found in training data. In particular, diffusion models can be used to generate novel images. Diffusion models can be used for various image generation tasks, including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image, or to image features generated by an encoder (e.g., latent diffusion).

Diffusion models work by iteratively adding noise to the data during a forward process and then learning to recover the data by denoising the data during a reverse process. For example, during training, diffusion model 800 may take an original image 805 in a pixel space 810 as input and apply an image encoder 815 to convert original image 805 into original image feature 820 in a latent space 825. Then, a forward diffusion process 830 gradually adds noise to the original image feature 820 to obtain noisy feature 835 (also in latent space 825) at various noise levels.

Next, a reverse diffusion process 840 (e.g., a U-Net ANN) gradually removes the noise from the noisy feature 835 at the various noise levels to obtain the denoised image feature 845 in latent space 825. In some examples, denoised image feature 845 is compared to the original image feature 820 at each of the various noise levels, and parameters of the reverse diffusion process 840 of the diffusion model are updated based on the comparison. Finally, an image decoder 850 decodes the denoised image feature 845 to obtain an output image 855 in pixel space 810. In some cases, an output image 855 is created at each of the various noise levels. The output image 855 can be compared to the original image 805 to train the reverse diffusion process 840. In some cases, output image 855 refers to the modified image (e.g., described with reference to FIGS. 4-6).

In some cases, image encoder 815 and image decoder 850 are pre-trained prior to training the reverse diffusion process 840. In some examples, image encoder 815 and image decoder 850 are trained jointly, or the image encoder 815 and image decoder 850 are fine-tuned jointly with the reverse diffusion process 840.

The reverse diffusion process 840 can also be guided based on a text prompt 860, or another guidance prompt, such as an image, a layout, a style, a color, a segmentation map, etc. The text prompt 860 can be encoded using a text encoder 865 (e.g., a multimodal encoder) to obtain guidance feature 870 in guidance space 875. The guidance feature 870 can be combined with the noisy feature 835 at one or more layers of the reverse diffusion process 840 to ensure that the output image 855 includes content described by the text prompt 860. For example, guidance feature 870 can be combined with the noisy feature 835 using a cross-attention block within the reverse diffusion process 840.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, enabling the machine learning model to understand the context and generate more accurate and contextually relevant outputs.

In some examples, diffusion models are based on a neural network architecture known as a U-Net. The U-Net takes input features having an initial resolution and an initial number of channels and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIGS. 7 and 9.

A diffusion process may also be modified based on conditional guidance. In some cases, a user provides a text prompt (e.g., text prompt 860) describing content to be included in a generated image. In some examples, guidance can be provided in a form other than text, such as via an image, a sketch, a color, a style, or a layout. The system converts text prompt 860 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 800 generates an image based on the noise map and the conditional guidance vector.

A diffusion process can include both a forward diffusion process 830 for adding noise to an image (e.g., original image 805) or features (e.g., original image feature 820) in a latent space 825 and a reverse diffusion process 840 for denoising the images (or features) to obtain a denoised image (e.g., output image 855). The forward diffusion process 830 can be represented as q(xₜ|xₜ₋₁), and the reverse diffusion process 840 can be represented as p_{θ}(xₜ₋₁|xₜ). Further detail on the diffusion process is described with reference to FIG. 11.

A diffusion model 800 may be trained using both a forward diffusion process 830 and a reverse diffusion process 840. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 830 in N stages. In some cases, the forward diffusion process 830 is a fixed process where Gaussian noise is successively added to an image. In latent diffusion models, the Gaussian noise may be successively added to features (e.g., original image feature 820) in a latent space 825.

At each stage n, starting with stage N, a reverse diffusion process 840 is used to predict the image or image features at stage n−1. For example, the reverse diffusion process 840 can predict the noise that was added by the forward diffusion process 830, and the predicted noise can be removed from the image to obtain the predicted image. In some cases, an original image 805 is predicted at each stage of the training process.

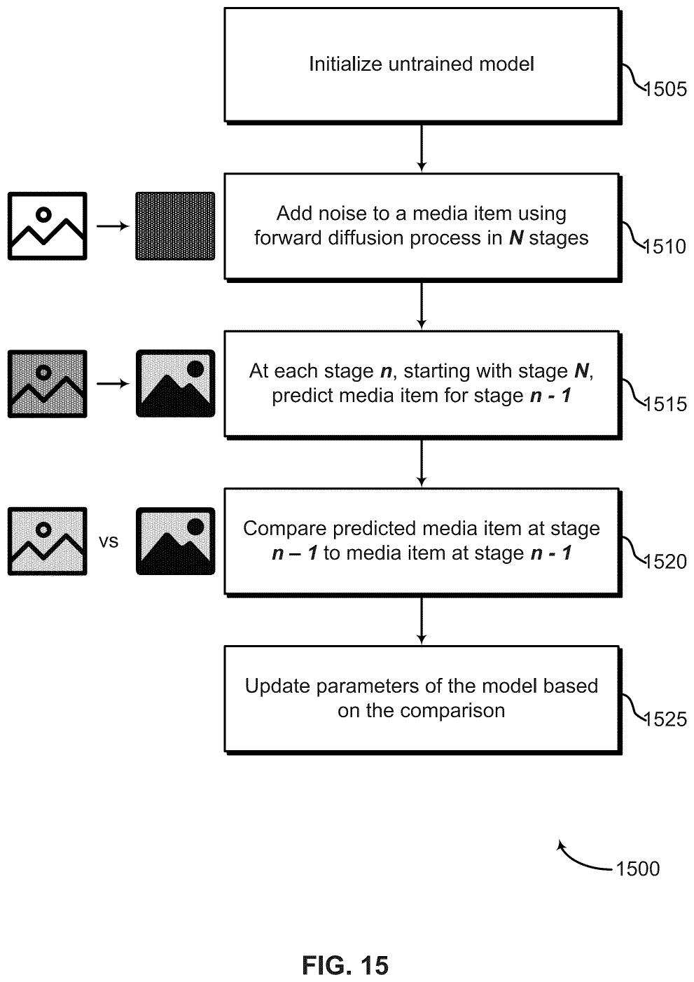

The training component (e.g., training component described with reference to FIG. 16) compares predicted image (or image features) at stage n−1 to an actual image (or image features), such as the image at stage n−1 or the original input image. For example, given observed data x, the diffusion model 800 may be trained to minimize the variational upper bound of the negative log-likelihood-log pe (x) of the training data. The training component then updates parameters of the diffusion model 800 based on the comparison. For example, parameters of a U-Net may be updated using gradient descent. Time-dependent parameters of the Gaussian transitions can also be learned. Further detail on training the diffusion model is described with reference to FIG. 15.

Original image 805 is an example of, or includes aspects of, the corresponding element described with reference to FIG. 11. Image encoder 815 is an example of, or includes aspects of, the corresponding element described with reference to FIGS. 6 and 16. Forward diffusion process 830 is an example of, or includes aspects of, the corresponding element described with reference to FIG. 11.

Reverse diffusion process 840 is an example of, or includes aspects of, the corresponding element described with reference to FIG. 11. Text prompt 860 is an example of, or includes aspects of, the corresponding element described with reference to FIG. 7. Text encoder 865 is an example of, or includes aspects of, the corresponding element described with reference to FIGS. 6, 7, and 16.

FIG. 9 shows an example of a U-Net 900 architecture according to aspects of the present disclosure. The example shown includes U-Net 900, input feature 905, initial neural network layer 910, intermediate feature 915, down-sampling layer 920, down-sampled feature 925, up-sampling process 930, up-sampled feature 935, skip connection 940, final neural network layer 945, and output feature 950.

In some examples, U-Net 900 is an example of the component that performs the reverse diffusion process 840 of diffusion model 800 described with reference to FIG. 8 and includes architectural elements of the image generation model 1630 described with reference to FIG. 16. The U-Net 900 depicted in FIG. 9 is an example of, or includes aspects of, the architecture used within the reverse diffusion process described with reference to FIG. 8.

In some examples, diffusion models are based on a neural network architecture known as a U-Net. The U-Net 900 takes input feature 905 having an initial resolution and an initial number of channels and processes the input feature 905 using an initial neural network layer 910 (e.g., a convolutional network layer) to produce intermediate feature 915. The intermediate feature 915 is then down-sampled using a down-sampling layer 920 such that the down-sampled feature 925 has a resolution less than the initial resolution and a number of channels greater than the initial number of channels.

This process is repeated multiple times, and then the process is reversed. For example, the down-sampled feature 925 is up-sampled using up-sampling process 930 to obtain up-sampled feature 935. The up-sampled feature 935 can be combined with intermediate feature 915 having the same resolution and number of channels via a skip connection 940. These inputs are processed using a final neural network layer 945 to produce output feature 950. In some cases, the output feature 950 has the same resolution as the initial resolution and the same number of channels as the initial number of channels.

In some cases, U-Net 900 takes an additional input feature to produce conditionally generated output. For example, the additional input feature could include a vector representation of an input prompt. The additional input feature can be combined with the intermediate feature 915 within the neural network at one or more layers. For example, a cross-attention module can be used to combine the additional input features and the intermediate feature 915.

U-Net 900 is an example of, or includes aspects of, the corresponding element described with reference to FIG. 7. Output feature 950 is an example of, or includes aspects of, the corresponding element described with reference to FIG. 7.

FIG. 10 shows an example of a diffusion transformer 1000 model according to aspects of the present disclosure. The example shown includes predicted noise 1005, predicted covariance 1010, linear and reshape layers 1015, normalization layer 1020, DiT block(s) 1025, patchify operation 1030, embedding 1035, noised latent 1040, timestep information 1045, label information 1050, and an implementation of one block in the DiT block(s) 1025 by a DiT Block 1096. In one aspect, the DiT Block 1096 includes second residual connection 1060, second scaling operations 1062, feed-forward network 1064, post-normalization second scaling and shifting 1066, second normalization 1068, first residual connection 1070, first scaling operations 1072, self-attention 1074, post-normalization first scaling and shifting 1076, first normalization 1078, input tokens 1080, conditioning tokens 1082, multi-layer perceptron (MLP) 1084, post-normalization first scaling and shifting parameters 1086, first scaling parameter 1088, post-normalization second scaling and shifting parameters 1090, and second scaling parameter 1092. In some embodiments, the architecture uses a Latent Diffusion Transformer 1094. In some embodiments, DiT Block 1096 uses an “adaLN-Zero” technique.

Diffusion Transformers (DiTs) is a popular architecture for diffusion models and is designed to be structurally faithful to standard transformer architecture. DiT incorporates the scaling properties of the transformer structures. For training denoising diffusion probabilistic models (DDPMs) of images (e.g., spatial representations of images), DiT is based on a Vision Transformer (ViT) architecture which operates on sequences of patches. DiT processes images by dividing the images into patches, converting these patches into tokens, and applying attention mechanisms to model relationships between different regions of the image. This approach enables the model to capture both local and long-range dependencies in the image generation process.

In some cases, input to DiT is a spatial representation z. For 256×256×3 images, z has shape 32×32×4. A first layer of a DiT is to carry out patchify operation, where the DiT divides an input image into patches and converts the patches (a form of spatial input) into a sequence of T tokens, each of dimension d, by linearly embedding each patch in the input. Following the patchify process, ViT frequency-based positional embeddings are applied to all input tokens. In some cases, the number of tokens T created by patchify is determined by a patch size hyperparameter p. In some cases, T=(I/p)², where I is another shape parameter, thus halving p quadruples T, which in some cases at least quadruples total of transformer Giga Floating Point Operations (Gflops). In some examples, changing p has no impact on downstream parameter counts, e.g., parameter counts in downstream layers of DiT is independent from p. In some examples, p=2, 4 or 8. Various patch sizes, transformer block architectures and model sizes are implemented.

Following Patchify operation, attention mechanisms are applied to model relationships between different regions of the image in one or more DiT blocks. In addition to noised image inputs, diffusion models sometimes process additional conditional information such as noise timesteps t, class labels c, natural language information, etc. Four variants of transformer blocks for processing conditional inputs including both input information and conditional information are described below.

In some cases, DiT blocks in the DiT network are implemented using adaptive layer norm (adaLN) blocks. Following adaptive normalization layers in generative adversarial networks (GANs) and conventional diffusion models with U-Net backbones, in some examples, standard normalization layers in transformer blocks are replaced with adaptive layer norm (adaLN). Rather than directly learning dimension-wise scale γ and shift parameters β, in adaLN the system regresses γ and β from a sum of the embedding vectors of the noise timesteps t and the class labels c. An adaLN adds relatively small numbers of Gflops and is more efficient. Additionally, adaLN is a conditioning mechanism that applies a same function to all tokens.

In some cases, DiT blocks in the DiT network are implemented using adaLN-Zero blocks, which leverages zero-initialization techniques. In Residual Networks (ResNets), initializing each residual block as the identity function x [symbol] x is beneficial. In some examples, zero-initializing a final batch norm scale factor γ in each block accelerates large-scale training in supervised learning settings. Diffusion models based on U-Nets use a similar initialization strategy, zero-initializing final convolutional layer in each block prior to residual connections. An adaLN-Zero block is modified from an adaLN block using similar zero-initialization techniques. In addition to regressing the dimension-wise scale γ and the shifting parameters β, the system also regresses dimension-wise scaling parameters as that are applied immediately prior to residual connections within the DiT block. The network initializes a multi-layer perceptron (MLP) to output a zero-vector for all as; this initializes an entire DiT block as the identity function. As with the adaLN block, adaLNZero adds negligible Gflops to the model.

In some cases, DiT blocks in the DiT network are implemented using in-context conditioning, where vector embeddings of t and c are appended as two additional tokens in the input sequence, and after a final block, the network removes the two conditioning tokens from the sequence.

In some cases, DiT blocks in the DiT network include cross-attention blocks. The DiT network concatenates the embeddings of t and c into a length-two sequence, separate from the image token sequence. The transformer block is modified to include an additional multi-head cross-attention layer following the multi-head self-attention block.

In some cases, the DiT network includes a sequence of N DiT blocks, each operating at a hidden dimension size d. Following ViT, the DiT network uses standard transformer configs that jointly scale N, d and attention heads. In some examples, Small(S), Base (B), Large (L) variants, XLarge (XL) variants of model sizes are implemented. Small or Base model sizes have N=12 layers of DiT blocks, large model sizes have 24 layers of DiT blocks. XLarge model sizes have 28 layers of DiT blocks.

After a final DiT block, the DiT network decodes the sequence of image tokens into an output noise prediction and an output diagonal covariance prediction. Both outputs have shape equal to an original spatial input. Standard linear decoder is utilized to decode, where a final normalization layer (or adaptive normalization layer if the DiT block is an adaLN block) and linearly decode each token into a p×p×2C tensor, where C is a number of channels in the spatial input to the DiT network and p is the patch size hyperparameter. Finally, decoded tokens are rearranged into the corresponding original spatial layout to get the predicted noise and covariance.

The diffusion transformer model, in some cases, employs a Latent Diffusion Transformer 1094. The diffusion transformer model processes noised latent 1040, which may be a noised version of an input image encoded in a latent space. Patchify operation 1030 divides the noised latent into a sequence of patches that are processed as tokens. The tokens are vector representations of each patch of the image in latent space and are adjusted through attention processes. Each of the tokens also receives timestep information 1045 and label information 1050 and the embedding 1035 encodes the current denoising timestep and class labels as conditional information. In some cases, embedding 1035 is referred to as conditional embedding or conditional information embedding. In some cases, a positional embedding which encodes each token's spatial position in the image is applied to the patchified input tokens at the patchify operation 1030. In some examples the positional embedding is VIT frequency-based positional embedding. The input tokens 1080 generated by the patchify operation 1030 and the conditioning tokens 1082 generated by the embedding 1035 are processed through N DiT block(s) 1025, where N may be 102, 24 or 28. Other values of N may be used. In some cases, conditional tokens refer to tokens generated based on embedding 1035, encoding timestep information 1045, and label information 1050.

Each of the DiT block(s) 1025 includes multiple processing stages. DiT Block 1096 illustrates an embodiment of one block in the DiT block(s) 1025. In some embodiments, the DiT Block 1096 is an example of, or includes aspects of, the adaLN-Zero block. In some cases, input tokens 1080 interact with the conditioning tokens 1082 through multiple attention mechanisms. Particularly, after first normalization 1078 applied to the input tokens and MLP 1084 to the conditional tokens, MLP 1084 generates or updates post-normalization first scaling and shifting parameters 1086, denoted as γ₁, β₁, for post-normalization first scaling and shifting 1076 to scale and shift the output of first normalization 1078 accordingly. As the normalized input tokens obtained from first normalization 1078 are scaled and shifted at post-normalization first scaling and shifting 1076 using the conditional information carried as least in γ₁, β₁, this allows the input information and conditional information to interact. Self-attention 1074 allows the scaled and shifted normalized input tokens, namely the output from post-normalization first scaling and shifting 1076, to attend to each other. MLP 1084 also generates or updates first scaling parameter 1088 denoted as α₁ for first scaling operations 1072 to scale the output of self-attention 1074 (e.g., multi-head self-attention), further interacting the input information and conditional information. The input tokens 1080 is then summed with the output of first scaling operations 1072 at first residual connection 1070. In some examples, α₁ has initial values 0, and the DiT Block 1096 is initialized as the identity function.

A similar process is performed in a second half of the DiT Block 1096. MLP 1084 generates or updates post-normalization second scaling and shifting parameters 1090, denoted as γ₂, β₂, for post-normalization second scaling and shifting 1066 to scale and shift the output of second normalization 1068 accordingly. As the output from second normalization 1068 is scaled and shifted using the conditional information carried at least in γ₂, β₂, this allows the input information and conditional information to further interact. Feed-forward network 1064 then processes the scaled and shifted output from post-normalization second scaling and shifting 1066. MLP 1084 also generates or updates the second scaling parameter 1092 denoted as α₂ for second scaling operations 1062 to scale the output of feed-forward network 1064, further interacting with the input information and conditional information. In some cases, the feed-forward network 1064 is a pointwise feed-forward network. The output from first residual connection 1070 is then summed with the output of second scaling operations 1062 at second residual connection 1060, and the result is the final output of DiT Block 1096. In some examples, α₂ has initial values 0, and the DiT Block 1096 is initialized as the identity function. This process repeats for each DiT block in the sequence.

After processing through all DiT block(s) 1025, the outputs undergo normalization layer 1020 followed by linear and reshape layers 1015. The final output is the predicted noise 1005, which represents the model's prediction of the noise that was added to initially create the noised latent 1040, and the predicted covariance 1010, which represents the model's prediction of the covariance. The predicted noise 1005 is removed from noised latent 1040 at each diffusion timestep, and the predicted covariance may affect how noise is removed or resampled in the reverse or denoising process. At the end of the denoising schedule, the latent sample is decoded to generate the synthetic image in pixel space.

### Diffusion Process

FIG. 11 shows an example of a diffusion process 1100 according to aspects of the present disclosure. The example shown includes diffusion process 1100, forward diffusion process 1105, reverse diffusion process 1110, noisy image 1115, first intermediate image 1120, second intermediate image 1125, and original image 1130.

Diffusion process 1100 can include forward diffusion process 1105 for adding noise to original image 1130 (e.g., original image 805 described with reference to FIG. 8) or features (e.g., original image feature 820 described with reference to FIG. 8) in a latent space. In some aspects, diffusion process 1100 includes reverse diffusion process 1110 for denoising the noisy image 1115 (or image features) to obtain a denoised image (or original image 1130). The forward diffusion process 1105 can be represented as q(xₜ|xₜ₋₁), and the reverse diffusion process 1110 can be represented as p_{θ}(xₜ₋₁|xₜ). In some cases, the forward diffusion process 1105 is used during training to generate images with successively greater noise, and a neural network is trained to perform the reverse diffusion process 1110 (e.g., to successively remove the noise).

In an example forward diffusion process 1105 for a latent diffusion model (e.g., diffusion model 800 described with reference to FIG. 8), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q x_{1:T}|x₀) as the latent variables are passed through a neural network such as a U-Net, where x₁, . . . , x_{T} have the same dimensionality as x₀.

The neural network may be trained to perform the reverse diffusion process 1110. During the reverse diffusion process 1110, the diffusion model begins with noisy data x_{T}, such as a noisy image 1115 and denoises the data to obtain the p_{θ}(xₜ₋₁|xₜ). At each step t−1, the reverse diffusion process 1110 takes xₜ, such as the first intermediate image 1120, and t as input. Here, t represents a step in the sequence of transitions associated with different noise levels, The reverse diffusion process 1110 outputs xₜ₋₁, such as the second intermediate image 1125, iteratively until x_{T} is reverted back to x₀, the original image 1130. The reverse diffusion process 1110 can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse diffusion process 1110 takes the outcome of the forward diffusion process 1105, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and x represents the generated image with high image quality.

Forward diffusion process 1105 is an example of, or includes aspects of, the corresponding element described with reference to FIG. 8. Reverse diffusion process 1110 is an example of, or includes aspects of, the corresponding element described with reference to FIG. 8. Original image 1130 is an example of, or includes aspects of, the corresponding element described with reference to FIG. 8.

### Training and Evaluation

In FIGS. 12-15, a method, apparatus, non-transitory computer readable medium, and system for image processing include obtaining a training set including a training image, a modification prompt describing a change to the training image, and a modified training image depicting the change to the training image; encoding, using a text encoder, the modification prompt to obtain a text embedding, wherein the text embedding represents the modification in an embedding space; and training, using the training set and the text embedding, an image generation model to generate a synthetic image based on the modification prompt.

In some aspects, the image generation model is trained to preserve an element of the training image that is not described by the modification prompt. In some aspects, the training set includes a mask input indicating a region of the training image, wherein the image generation model is trained to generate the synthetic image based on the mask input.

Some examples of the method, apparatus, non-transitory computer readable medium, and system further include generating a first predicted image based on a caption for the training image. Some examples of the method, apparatus, non-transitory computer readable medium, and system further include generating a second predicted image based on the modification prompt.

Some examples of the method, apparatus, non-transitory computer readable medium, and system further include generating first image features based on the training image. Some examples of the method, apparatus, non-transitory computer readable medium, and system further include generating second image features based on the modification prompt. Some examples of the method, apparatus, non-transitory computer readable medium, and system further include combining the first image features and the second image features to obtain combined image features.

Some examples of the method, apparatus, non-transitory computer readable medium, and system further include computing a diffusion loss, wherein the image generation model is trained based on the diffusion loss. Some examples of the method, apparatus, non-transitory computer readable medium, and system further include modifying a color of the training image to obtain the modified training image.

Some examples of the method, apparatus, non-transitory computer readable medium, and system further include identifying a caption of the training image. Some examples further include generating the training prompt based on the caption. Some examples of the method, apparatus, non-transitory computer readable medium, and system further include segmenting the first predicted image to obtain a mask indicating a location of the object, where the second predicted image is based on the mask.

Some examples of the method, apparatus, non-transitory computer readable medium, and system further include generating a first predicted image based on the caption. Some examples further include generating a second predicted image based on the training prompt. Some examples further include computing a loss function based on the first predicted image and the second predicted image. Some examples further include updating parameters of the image generation model based on the loss function.

FIG. 12 shows an example of a method 1200 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system obtains a training set including a training image, a modification prompt describing a change to the training image, and a modified training image depicting the change to the training image. In some cases, the operations of this step refer to, or may be performed by, a training component as described with reference to FIG. 16. Further detail on obtaining the training set is described with reference to FIG. 13.

At operation 1210, the system encodes, using a text encoder, the modification prompt to obtain a text embedding, wherein the text embedding represents the modification in an embedding space. In some cases, the operations of this step refer to, or may be performed by, a training component as described with reference to FIG. 16. In some cases, the operations of this step refer to, or may be performed by, a text encoder described with reference to FIG. 16. Further detail on training the image generation model is described with reference to FIG. 13.

At operation 1210, the system trains, using the training set and the text embedding, an image generation model to generate a synthetic image based on the modification prompt. In some cases, the operations of this step refer to, or may be performed by, a training component as described with reference to FIG. 16. Further detail on training the image generation model is described with reference to FIG. 13.

FIG. 13 shows an example of training data generation according to aspects of the present disclosure. The example shown includes training system 1300, original dataset 1305, text-image pair 1310, text caption 1315, training image 1320, training language generation model 1325, training prompt 1330, training image generation model 1335, first predicted image 1340, second predicted image 1345, segmentation model 1350, and training mask 1355. In one aspect, the training system 1300 includes training language generation model 1325, training image generation model 1335, and segmentation model 1350.

Referring to FIG. 13, a training component (e.g., the training component described with reference to FIG. 16) trains the image generation model (e.g., the training image generation model 1335) using the training dataset obtained from the original dataset 1305. For example, original dataset 1305 includes text-image pair 1310, where the text-image pair 1310 includes a training image 1320 and a text caption 1315 describing one or more elements of the training image 1320. For example, the text caption 1315 states “Steak cooking over grill.”

The training language generation model 1325 generates a training prompt 1330 based on the text caption 1315 by modifying an element from the text caption. For example, the training prompt 1330 states, “Fish cooking over grill.” For example, the training language generation model 1325 replaced steak from text caption 1315 with fish in the training prompt 1330. In some cases, the training language generation model is a pretrained model, for example, Llama2.

In some embodiments, the training image generation model 1335 generates predicted images based on the prompts. For example, the training image generation model 1335 generates the first predicted image 1340 depicting steak cooking on the grill based on the text caption 1315. For example, the training image generation model 1335 generates a second predicted image 1345 depicting fish cooking on the grill based on the training prompt 1330. In some embodiments, the first predicted image 1340 is provided to the segmentation model 1350 to generate a training mask 1355. In some cases, the training mask 1355 is provided to the training image generation model 1335 to guide the image generation process to generate the second predicted image 1345.

According to some embodiments, the training data includes a prompt, an input image, and an output image. In some cases, the training data further includes a mask. In some cases, the training data includes reference inputs to further train the image generation model. For example, the reference inputs include a fine-grained color image, texture image, and style image.

In some embodiments, the training data is filtered to generate the training set used to train the image generation model. In some cases, for example, a large language model (LLM) or a language generation model is used to generate the training set. For example, a pre-trained language generation model (e.g., LLAVA-based model) is finetuned with 1M labeled data. In some aspects, the language generation model takes an original image, a modified image, and a text instruction as inputs and generates outputs that evaluate whether the paired images (e.g., the original image and the modified image) align with the text instruction while maintaining identity preservation.

In some embodiments, the training component generates instructions (e.g., the training prompt 1330) using the language generation model. In some cases, the language generation model is able to identify and extract entities from the text caption. In some cases, the language generation model generates variations of the training prompts. According to some embodiments, mask control is applied to the image generation model to enhance the image quality. For example, a mask is applied to each of the denoising steps of the image generation process to ensure local editing.

According to some embodiments, the image generation model is fine-tuned or refined to perform identity preservation. For example, the system interpolates the image features (e.g., the DINO features) of the input image and the modified image to enhance identity preservation. For color modifications, the model is trained using ControlNet and an image generation model (e.g., ClioMD). For example, a masked grayscale input image is used as input. In some cases, an edge map is used to further condition the image generation model. In some cases, the region outside of the mask includes original pixels from the input image and the region within the mask is grayscale. Accordingly, the system ensures that the color modification is performed within the region indicated by the mask. According to some embodiments, the system performs texture-based editing, where the texture input is converted to synthesized data.

According to some aspects, the system is jointly trained with multi-tasks including inpainting, outpainting, editing tasks, segmentation, depth estimation, normal estimation, colorization, and low-level vision. For example, inpainting is a technique that fills in missing or corrupted parts of an image by predicting the content based on surrounding pixels. Inpainting is used in tasks like restoring damaged photos or removing objects from scenes. For example, outpainting involves extending an image beyond the original boundaries of the image, generating new content that aligns with the existing scene. For example, editing tasks involve modifying specific areas of an image, such as changing colors, textures, or even object placements while maintaining the coherence of the original content.

For example, segmentation is the process of dividing an image into one or more regions or objects based on certain features, such as color, texture, object, semantics, or entity. For example, depth estimation predicts the distance of objects from a viewpoint in a scene. For example, colorization involves adding colors to grayscale images by predicting the appropriate shades for each pixel in the grayscale image. For example, low-level vision involves extracting features such as edges, textures, and gradients from an image.

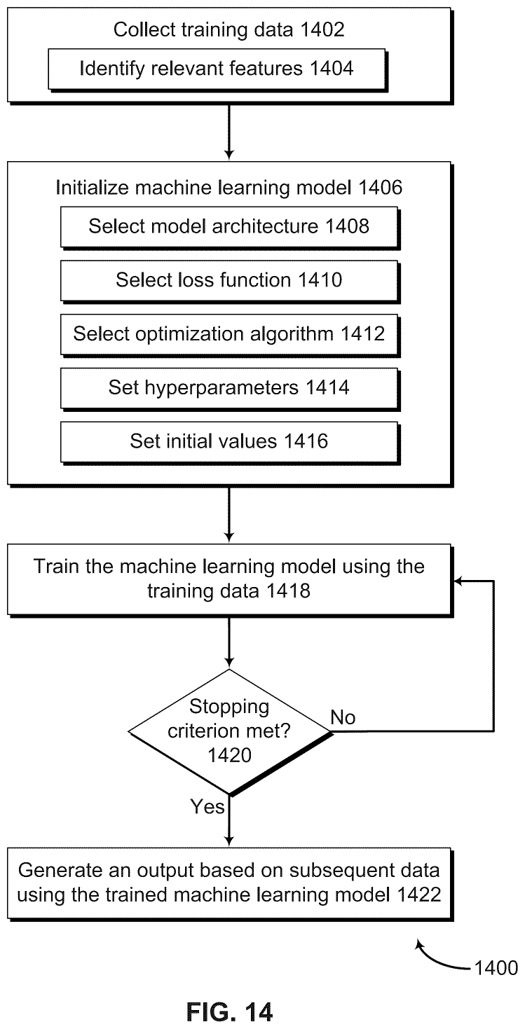

FIG. 14 shows an example of a flow diagram depicting an algorithm as a step-by-step procedure in an example implementation of operations performable for training a machine learning model according to aspects of the present disclosure. In some embodiments, the procedure 1400 describes an operation of the training component 1635 described for configuring the image generation model 1630 as described with reference to FIG. 16. The procedure 1400 provides one or more examples of generating training data, use of the training data to train a machine-learning model, and use of the trained machine-learning model to perform a task.

To begin in this example, a machine-learning system collects training data (block 1402) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1406). Initialization of the machine-learning model includes selecting a model architecture (block 1408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1410). The loss function is utilized to measure a difference between an output of the machine-learning model (e.g., the model predictions) and target values (e.g., as expressed by the training data) to be used to train the machine-learning model. Additionally, an optimization algorithm is selected (block 1412) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1416) examples of which include initializing weights and biases of nodes to increase efficiency in training and computational resources consumption as part of training. Hyperparameters are also set (block 1414) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1420), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1420), procedure 1400 continues the training of the machine-learning model using the training data (block 1418) in this example.

If the stopping criterion is met (“yes” from decision block 1420), the trained machine-learning model is then utilized to generate an output based on subsequent data (block 1422). The trained machine-learning model, for instance, is trained to perform a task as described above and therefore once trained is configured to perform that task based on subsequent data received as an input and processed by the machine-learning model.

FIG. 15 shows an example of a method 1500 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

In some embodiments, the method 1500 describes an operation of the training component 1635 described for training the image generation model 1630 as described with reference to FIG. 16. The method 1500 represents an example for training a reverse diffusion process as described above with reference to FIG. 11. In some examples, these operations are performed by a system including a processor executing a set of codes to control functional elements of an apparatus, such as the image generation model described in FIG. 16.

At operation 1505, the system initializes untrained model. In some cases, the operations of this step refer to, or may be performed by, a training component as described with reference to FIG. 16. Initialization can include defining the architecture of the model and establishing initial values for the model parameters. In some cases, the initialization can include defining hyper-parameters such as the number of layers, the resolution and channels of each layer block, the location of skip connections, and the like.

At operation 1510, the system adds noise to media item using forward diffusion process in N stages. In some cases, the operations of this step refer to, or may be performed by, a training component as described with reference to FIG. 16. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1515, the system at each stage n, starting with stage N, predict media item for stage n−1. In some cases, the operations of this step refer to, or may be performed by, a training component as described with reference to FIG. 16. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1520, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 16. For example, given observed data x, the diffusion model may be trained to minimize the variational upper bound of the negative log-likelihood −log p_{θ}(x) of the training data.

At operation 1525, the system updates parameters of the model based on the comparison. In some cases, the operations of this step refer to, or may be performed by, a training component as described with reference to FIG. 16. For example, parameters of a U-Net may be updated using gradient descent. Time-dependent parameters of the Gaussian transitions can also be learned.

### System Apparatus

FIG. 16 shows an example of an image processing apparatus 1600 according to aspects of the present disclosure. The example shown includes image processing apparatus 1600, processor unit 1605, I/O module 1610, memory unit 1615, and training component 1635. In one aspect, memory unit 1615 includes text encoder 1620, image encoder 1625, and image generation model 1630.

According to some embodiments of the present disclosure, image processing apparatus 1600 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 1600 is an example of, or includes aspects of, the corresponding element described with reference to FIG. 1.

Processor unit 1605 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 1605 is configured to operate a memory array using a memory controller. In other cases, a memory controller is integrated into the processor. In some cases, processor unit 1605 is configured to execute computer-readable instructions stored in a memory to perform various functions. In some embodiments, processor unit 1605 includes special-purpose components for modem processing, baseband processing, digital signal processing, or transmission processing. Processor unit 1605 is an example of, or includes aspects of, the processor described with reference to FIG. 17.

I/O module 1610 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 1610 includes a user interface. A user interface may enable a user to interact with a device. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 1610 is an example of, or includes aspects of, the I/O interface described with reference to FIG. 17.

Examples of memory unit 1615 include random access memory (RAM), read-only memory (ROM), or a hard disk. Examples of memory unit 1615 include solid-state memory and a hard disk drive. In some examples, memory unit 1615 is used to store computer-readable, computer-executable software including instructions that, when executed, cause a processor to perform various functions described herein.

In some cases, memory unit 1615 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 1615 store information in the form of a logical state.

In one aspect, memory unit 1615 includes a machine learning model. In one aspect, the machine learning model includes text encoder 1620, image encoder 1625, and image generation model 1630. Memory unit 1615 is an example of, or includes aspects of, the memory subsystem described with reference to FIG. 17.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 1615 and executable by processor unit 1605, as firmware, as one or more hardware circuits, or as a combination thereof.

According to some embodiments of the present disclosure, machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge are associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, a machine learning model includes machine learning parameters. Machine learning parameters, also known as model parameters or weights, are variables that provide behavior and characteristics of machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, a machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, a machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence), and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, which allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, text encoder 1620 is implemented as software stored in memory unit 1615 and executable by processor unit 1605, as firmware, as one or more hardware circuits, or as a combination thereof. According to some aspects, text encoder 1620 generates a text embedding based on the modification prompt, where the text embedding represents the modification in an embedding space. According to some aspects, text encoder 1620 encodes the modification prompt to obtain a text embedding, where the text embedding represents the modification in an embedding space. Text encoder 1620 is an example of, or includes aspects of, the corresponding element described with reference to FIGS. 6-8.

According to some aspects, image encoder 1625 is implemented as software stored in memory unit 1615 and executable by processor unit 1605, as firmware, as one or more hardware circuits, or as a combination thereof. According to some aspects, image encoder 1625 obtains a reference input. In some examples, image encoder 1625 generates a reference embedding based on the reference input, where the modified image is generated based on the reference embedding. In some examples, image encoder 1625 generates first image features based on the input image. In some examples, image encoder 1625 generates second image features based on the text embedding. Image encoder 1625 is an example of, or includes aspects of, the corresponding element described with reference to FIGS. 6 and 8.

According to some aspects, image generation model 1630 is implemented as software stored in memory unit 1615 and executable by processor unit 1605, as firmware, as one or more hardware circuits, or as a combination thereof. According to some aspects, image generation model 1630 obtains an input image and a modification prompt, where the input image depicts an object with a first attribute and the modification prompt describes a modification from the first attribute to a second attribute different from the first attribute. In some examples, image generation model 1630 generates a modified image based on the input image and the text embedding, where the modified image depicts the object with the second attribute. In some aspects, the modified image preserves a third attribute of the object.

In some examples, image generation model 1630 obtains a mask input indicating a region of the input image, where the modified image is generated based on the mask input. In some examples, image generation model 1630 obtains noise input. In some examples, image generation model 1630 denoises the noise input based on the text embedding to obtain the modified image. In some examples, image generation model 1630 modifies a color of the input image to obtain a modified input image, where the modified image is generated based on the modified input image.

In some examples, image generation model 1630 combines the first image features and the second image features to obtain combined image features, where the modified image is generated based on the combined image features. In some aspects, the image generation model 1630 is trained to edit images using a training set including a training image depicting the object with the first attribute and a training prompt describing the modification from the first attribute to the second attribute. In some aspects, the image generation model 1630 is trained using a first predicted image generated based on a caption and a second predicted image generated based on a change to the caption.

In some aspects, image generation model 1630 includes a diffusion model. In some aspects, image generation model 1630 includes a U-Net architecture. In some aspects, image generation model 1630 includes a diffusion transformer. Image generation model 1630 is an example of, or includes aspects of, the corresponding element described with reference to FIG. 6.

### Computing Device

FIG. 17 shows an example of a computing device 1700 according to aspects of the present disclosure. The example shown includes computing device 1700, processor 1705, memory subsystem 1710, communication interface 1715, I/O interface 1720, user interface component 1725, and channel 1730.

In some embodiments, computing device 1700 is an example of, or includes aspects of, the image processing apparatus described with reference to FIGS. 1 and 16. In some embodiments, computing device 1700 includes processor 1705 that can execute instructions stored in memory subsystem 1710 to obtain an input image and a modification prompt, generate a text embedding based on the modification prompt, and generate a modified image based on the input image and the text embedding.

According to some embodiments, processor 1705 includes one or more processors. In some cases, processor 1705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1705 is configured to operate a memory array using a memory controller. In other cases, a memory controller is integrated into processor 1705. In some cases, processor 1705 is configured to execute computer-readable instructions stored in a memory to perform various functions. In some embodiments, processor 1705 includes special-purpose components for modem processing, baseband processing, digital signal processing, or transmission processing. Processor 1705 is an example of, or includes aspects of, the processor unit described with reference to FIG. 16.

According to some embodiments, memory subsystem 1710 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1710 is an example of, or includes aspects of, the memory unit described with reference to FIG. 16.

According to some embodiments, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1715.

According to some embodiments, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or hardware components controlled by the I/O controller. I/O interface 1720 is an example of, or includes aspects of, the I/O module described with reference to FIG. 16.

According to some embodiments, user interface component 1725 enables a user to interact with computing device 1700. In some cases, user interface component 1725 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIGS. 4-5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and a modification prompt, wherein the input image depicts an object with a first attribute and the modification prompt describes a modification from the first attribute to a second attribute different from the first attribute;
encoding, using a text encoder, the modification prompt to obtain a text embedding, wherein the text embedding represents the modification in an embedding space; and
generating, using an image generation model, a modified image based on the input image and the text embedding, wherein the modified image depicts the object with the second attribute.

2. The method of claim 1, wherein:
the modified image preserves a third attribute of the object.

3. The method of claim 1, further comprising:
obtaining a mask input indicating a region of the input image, wherein the modified image is generated based on the mask input.

4. The method of claim 1, further comprising:
obtaining a reference input; and
generating a reference embedding based on the reference input, wherein the modified image is generated based on the reference embedding.

5. The method of claim 1, further comprising:
obtaining noise input; and
denoising the noise input based on the text embedding to obtain the modified image.

6. The method of claim 1, further comprising:
modifying a color of the input image to obtain a modified input image, wherein the modified image is generated based on the modified input image.

7. The method of claim 1, further comprising:
generating first image features based on the input image;
generating second image features based on the text embedding; and
combining the first image features and the second image features to obtain combined image features, wherein the modified image is generated based on the combined image features.

8. The method of claim 1, wherein:
the image generation model is trained to edit images using a training set comprising a training image depicting the object with the first attribute and a training prompt describing the modification from the first attribute to the second attribute.

9. The method of claim 1, wherein:
the image generation model is trained using a first predicted image generated based on a caption and a second predicted image generated based on a change to the caption.

10. A method of training a machine learning model, the method comprising:
obtaining a training set including a training image, a modification prompt describing a change to the training image, and a modified training image depicting the change to the training image;
encoding, using a text encoder, the modification prompt to obtain a text embedding, wherein the text embedding represents the modification in an embedding space; and
training, using the training set and the text embedding, an image generation model to generate a synthetic image based on the modification prompt.

11. The method of claim 10, wherein:
the image generation model is trained to preserve an element of the training image that is not described by the modification prompt.

12. The method of claim 10, wherein:
the training set includes a mask input indicating a region of the training image, wherein the image generation model is trained to generate the synthetic image based on the mask input.

13. The method of claim 10, wherein training the image generation model comprises:
generating a first predicted image based on a caption for the training image; and
generating a second predicted image based on the modification prompt.

14. The method of claim 10, further comprising:
generating first image features based on the training image;
generating second image features based on the modification prompt; and
combining the first image features and the second image features to obtain combined image features.

15. The method of claim 10, wherein training the image generation model comprises:
computing a diffusion loss, wherein the image generation model is trained based on the diffusion loss.

16. The method of claim 10, wherein obtaining the training set comprises:
modifying a color of the training image to obtain the modified training image.

17. A system comprising:
a memory component; and
a processing device coupled to the memory component, the processing device configured to perform operations comprising:
obtaining an input image and a modification prompt, wherein the input image depicts an object with a first attribute and the modification prompt describes a modification from the first attribute to a second attribute different from the first attribute;
encoding, using a text encoder, the modification prompt to obtain a text embedding, wherein the text embedding represents the modification in an embedding space; and
generating, using an image generation model, a modified image based on the input image and the text embedding, wherein the modified image depicts the object with the second attribute.

18. The system of claim 17, wherein:
the image generation model comprises a diffusion model.

19. The system of claim 17, wherein:
the modified image preserves a third attribute of the object.

20. The system of claim 17, further comprising:
a reference encoder configured to generate a reference embedding based on a reference input, wherein the modified image is generated based on the reference embedding.
